(19) United States
(12) Patent Application Publication
(10) Pub. No.: US 2006/0073976 A1
(43) Pub. Date: Apr. 6, 2006

(54) Method of gravity distortion and time displacement

(76) Inventor: Marlin B. Pohlman, Tulsa, OK (US)

Correspondence Address: STITES & HARBISON PLLC, 1199 NORTH FAIRFAX STREET, SUITE 900, ALEXANDRIA, VA, 22314, US

(21) Appl. No.: 10/954,767

(22) Filed: Oct. 1, 2004

(51) Int. Cl. F16C 39/06; G01V 7/00; G09B 23/06; F41B 6/00; H01S 3/09

(52) U.S. Cl. 505/166; 505/180; 434/300; 73/382 G; 505/164

(57) ABSTRACT

A method for employing sinusoidal oscillations of electrical bombardment on the surface of one Kerr type singularity in close proximity to a second Kerr type singularity in such a method to take advantage of the Lense-Thirring effect, to simulate the effect of two point masses on nearly radial orbits in a 2+1 dimensional anti-de Sitter space resulting in creation of circular timelike geodesics conforming to the van Stockum under the Van Den Broeck modification of the Alcubierre geometry (Van Den Broeck 1999) permitting topology change from one spacelike boundary to the other in accordance with Geroch's theorem (Geroch 1967) which results in a method for the formation of G\ddot{}odel-type geodesically complete spacetime envelopes complete with closed timelike curves.

### FIELD OF THE INVENTION

The present invention relates to the use of technical time displacement devices, which operate by the modification of gravitational fields. These drive systems do not depend on the emission of matter to create thrust to take advantage of time dilation, but rather create a change in the curvature of space-time, in accordance with general relativity. This allows travel across topologies by warping space-time, to produce a topology change from one spacelike boundary to the other in accordance with Geroch's theorem (Geroch 1967)

### THEORETICAL BACKGROUND OF THE INVENTION

The concept of gravity should be examined in the light of quantum gravity and in turn as a component of quantum physics itself. The fundamental minimal quantum of energy in quantum physics is Planck's constant; h. Thus in accordance with the energy equivalence formula E=mc², the fundamental minimum quantity of mass (m_{q}) can therefore be derived, from known constants by; m_{q}=h/c² (1). Taking this minimal mass, it is possible to show that the formation of all matter, the forces of nature and indeed space-time itself derive from this single quintessential quantity.

Thus if the number of quintessences in a system is; n_{q}=m/m_{q}: then the total Energy of the system is more logically given by, the energy of a single quintessence (h); directly multiplied by the number of quintessences (n_{q}) in that system, thus
E=hn_{q}=mc² (1 a).

Furthermore, this minimal mass, termed quintessence, can form the basis of the existence of a quantum gravitational field in the form of a space-time lattice, from which quantum gravity may be derived from first principles. Furthermore, the conglomeration of these quintessences also accounts for the formation of the elementary particles and the forces acting between them, as in superstring theory. This concept explains the formation of matter and the forces of nature on a quantum mechanical basis and directly explains the existence of wave particle duality. Thus as n_{q}=m/m_{q}; the frequency of light and matter (f) is determined, directly, from the number of constituent quintessences. This leads automatically to the fundamental equation, derived from (1), f=n_{q}=E/h, where n_{q} is the number of quintessences, which leads directly to the frequency of both light and matter. This in turn leads directly to a Universal wave equation for matter and light λ=c/βn_{q}=hc/βE (2), where β is the relative directional velocity, v/c. As the momentum, p=β×E/c, then this equation also gives the standard de-Broglie wave equation, λ=h/p in agreement with current theory and experiments¹.

Using the Universal wave equation, the standard equation for special relativity, m′=mₒ/(1−β²)^{1/2}, derives from first principles. Also from these observations, a modified Dirac wave equation may be derived, Eψ=(−jβ·∇+βm)ψ (2a), the results of which have been recently verified by a paper in which the orbitals of electrons were experimentally directly visualised². Moreover, a fundamental equation for general relativity can be formulated, where G is the gravitational constant and r_{q} is the given radius of quintessence; G=9(r_{q})²c⁴/λβE (3), such that the Universal wave equation is in direct agreement with general relativity³. Thus special and general relativity and quantum mechanics can be unified.

From here it is possible to proceed in a number of ways; the geometric structure of the electron and the forces of Nature may be derived from first principles and in turn the structure of the quarks, including the top and bottom, otherwise known as truth and beauty can be seen. Moreover, the presence of a space-time lattice results in an understanding of quantum EPR effects. By allowing a theoretical flow of energy through the space-time lattice it can be shown that:

Energy is not bound by space-time

Thus logically accounting for phenomena such as entanglement and quantum tunnelling. Quintessence can also be used to explain, logically, the inner physics of a black hole, the missing mass of the Galaxy, the continuing expansion of the Universe, Guth's inflationary theory and the Big Bang. Hence, it is now possible to understand the Universe, including space-time, matter and the forces of nature from the radius, mass and vibration of a single quantity, quintessence.

With this understanding of space-time, matter and the forces of Nature, and in particular gravity, it is possible to demonstrate that the modification of gravitational fields, and in turn the warping of space-time, can be technically readily achieved.

Using standard equations for special relativity, m′=m₀/(1−β²)^{1/2}, it can be demonstrated that by differentially increasing the velocity of electrons, by applying a differential current, their mass can be increased in a specific way. In turn by increasing the mass of electrons, by general relativity, the number of gravitons emitted from these electrons can be modulated. By multiplying this effect using an ultracentrifugational device the differential graviton emission can be manifestly amplified. This in turn, in accordance with general relativity, will cause a change in the curvature of space-time.

This effective warping of space-time does not, of necessity, imply superluminal velocities, but does allow the creation of warp drive systems, which do not depend on the creation of thrust by the ejection of material as used in current space technologies.

### Part 1—Fundamental Laws of Physics

Quintessential Mass

The quantum physical, minimum component of energy is Planck's constant; h. To define the minimal component of mass, using the standard energy equivalence formula; E=mc², such a minimal mass (m_{q}) would be required to have the value equivalent to; m_{q}=h/c² (1). The total mass of a system (m) would then be; m=n_{q}m_{q}, where (n_{q}) is the number of these minimal units. Thence, the total energy of a system can be derived from the minimal energy; h, multiplied by the number of these energy units (n_{q}). Thus as, E=mc², then also E=m_{q}n_{q}c² and substituting m_{q}=h/c², the energy equivalence formula has the more logical formulation; E=hn_{q}(1a). Thus the energy of a system is equivalent to the minimal energy unit; h, multiplied by the number of those minimal energy units (n_{q}).

Taking this minimal mass/energy, it is possible to show that all matter, the forces of nature and space time can be constructed from this single quintessential quantity. Moreover, using this quantity the laws of physics can be derived from first principles. Thus, a priori, all components of the physical universe, including space-time, can be constructed from this minimal mass component, termed quintessence.

Wave Particle Duality

If the presence of quintessence accounts for the structure of matter and if matter itself forms from the number of quintessences, then the frequency of matter and thus wave particle duality directly arises from first principles. Specifically the wavelength of matter derives from the vibration of quintessence from which it is constituted. Thus the frequency (f) and in turn the wavelength of light and matter is directly equivalent to the number of quintessences contained within it. We find that the actual frequency of light can be directly derived from first principles from the effective mass of the photon (m,) and thus by the number of quintessences (n_{q}) it contains.

Thus for light conventionally:
f=E/h

and if E=mc², and h=m_{q}c², then
f=m_{γ}c²/m_{q}c²
and
f=m_{γ}/m_{q}=n_{q}
Thus
f=n_{q} (4)

Thus the formula for the frequency of light E=hf is now readily explained by the observation that the frequency is determined quite directly from the number of quintessences n_{q} within the photon.

The wavelength is thus also given by:
λ=c/f=m_{qc}/m_{γ}=h/p

We can now show that the frequency of matter also has the same derivation from quintessence, as has the frequency of light. The frequency of matter is again equivalent to the number of quintessences it contains. Thus the wave particle duality of matter itself can be explained by its composition from quintessence. The amount of quintessences contained within a electron sphere will depend on the number of quintessences constituting the electron and those passing through it as a result of its relative velocity β² (where β=v/c); effectively its relativistic momentum (p). The frequency will then be related to the total number of quintessences. Thus for matter,
f=β²n_{q} (4a)

Thus it is possible to derive the conventional de Broglie wave equation for matter from first principles. Thus, as λ=v/f, we have:
λ=v/β²n_{q} (5)

thus as n_{q}=E/h
λ=hc/βE (2)

and as conventionally βE/c=p, then for matter:
λ=h/p

Provided that in the de Broglie equation, the momentum of the object is calculated using the relativistic mass, thus accounting for the total number of quintessences n_{q} in an object, this gives an accurate value for the wavelength of matter¹.

Thus the wavelength of matter follows directly from its constituents, quintessence. As matter is made of quintessence, similarly to light, its frequency depends on the number of quintessences n_{q} within it, traveling relative to the speed of light. Moreover, λ=hc/βE, underpins a fundamental relationship between wavelength and energy. Furthermore, this is mathematically the same as the term λ=hv/β²E, giving a relativistic expression for the wavelength of matter, from which the relativistic equations may be directly derived

Wave Equations

The derivation of wave particle duality from first principles also now allows the derivation of a modified wave equation for matter.

To derive his wave equation Shrodinger commenced with the de Broglie equation using momentum (p). For lower energies the momentum of an electron is conventionally derived from the kinetic energy of the electron and the mass of the electron m₀. Thus conventionally:

$$\begin{matrix}\begin{matrix}{E}_{k} = \frac{1}{2} {mv}^{1 / 2} & and & p = {m}_{0} v\end{matrix} \\ Thus \\ {E}_{k} = {p}^{2} / 2 {m}_{0} \\ then \\ p = \sqrt{( {E}_{k} \cdot 2 {m}_{0} )}\end{matrix}$$

and conventionally, the de Broglie equation can also be written as:
λ=h/p=h/\sqrt{(Eₖ·2m₀)}

In turn the Shrodinger wave equation directly derives from the square of the above classical non relativistic term for kinetic energy:

$$\begin{matrix}{λ}^{2} = {h}^{2} / {E}_{k} \cdot 2 {m}_{0} \\ thus {E}_{k} = \frac{{h}^{2}}{2 m} \cdot \frac{1}{{λ}^{2}} \\ As E = {E}_{k} + V \\ then E ψ = - \frac{{h}^{2}}{2 m} \cdot \frac{{ⅆ}^{2} ψ}{ⅆ {x}^{2}} + V ψ = j h \cdot \frac{ⅆ ψ}{ⅆ t}\end{matrix}$$

However, the Shrodinger equation, may be refined by taking into account relativity. Thus the true values for the energy are given by the relativistic momentum (p).

A fundamental relativistic wave equation for ψ, and its logical derivation may now be developed through the concept of quintessence as a fundamental constituent of matter.

The amount of quintessences in the electron is determined by the number of quintessences forming the electron at rest, plus the amount of quintessences passing through it due to its relativistic velocity, which will determine the relativistic momentum (p) of a particle.

The frequency of matter can now be readily calculated from first principles to give a more accurate result. Thus as matter is made of quintessence, similarly to light, its frequency is equal to the number of quintessences n_{q} within it. The wavelength will depend on its velocity travelling relative to the speed of light and thus multiplied by the relative velocity compared to c(β=v/c);

Hence for matter as previously shown:
β=v/β²n_{q}=hc/βE (2)

And conventionally
E=(p²c²+m₀²c⁴)^{1/2}

Using these equations, we can now, also, reformulate the Shrodinger wave equation, which has the advantage that relativity can be treated in a quantum mechanical way. Thus if the wave energy of matter is defined as:

$$\begin{matrix}{E}_{λ} = \frac{β \sqrt{{p}^{2} {c}^{2} + {m}_{0}^{2} {c}^{4}}}{{c}^{2}} \\ thus \\ {E}_{λ} = \sqrt{( {β}^{2} {p}^{2} / {c}^{2} ) + {β}^{2} {m}_{0}^{2}}\end{matrix}$$

which in complex space generalises to
E_{ψ}=(−jβ·∇+βm)_{ψ} (2a)

As the term

$$α = \frac{{e}^{2}}{hc} 4 π {ɛ}_{0} ;$$

also represents the ground state ratio of the velocity of the electron to c. Thus α=β=v/c=1/137.

Thus, also
E_{ψ}=(−jα·∇+βm)_{ψ}

This is thus the standard relativistic equation that Dirac was able to construct from the Shrodinger wave equation. This relativistic equation can be derived from the modified wave equation. This takes into account the relative mass energy which the quintessential wave equation contains.

Where importantly the term β·m is the mass m, multiplied by the ratio of the relative velocity to light β=v/c, and the term a is also essentially the relative velocity of the electron.

The Dirac equation was an empirical formula which worked mathematically, nevertheless even Dirac admitted it was not logically understood. The importance of these equations is that they show that the existence of quintessence allows the waveparticle duality of matter to be explained and mathematically derived from first principles, Thus the frequency of matter or even light is simply determined by the number of quintessences it contains.

Indeed, a recent publication in Nature has suggested that the direct visualisation of the orbitals of electrons shows that these are in very close agreement with theory. However, there is a significant departure from theory, in the interstitial molecular regions, suggesting that the higher velocities of the electrons obey the modified Dirac equation. Thus these orbitals were in keeping with the modified Dirac equation, which itself may be derived from the wave equation above, λ=hc/βE

The Shrodinger wave equation will approximate to the correct values until v approaches c. Indeed the Shrodinger equation will give similar answers as that derived from equation, under most experimental conditions.

However, equation 2 and its derivative may have advantages over standard Shrodinger theory with relativistic speeds. Furthermore, equation 2, conceptually shows that the wave particle duality of matter derives from the principle that the frequency of matter is directly equal to the number of quintessences it contains. Importantly it also mathematically allows relativity and quantum mechanics to be united.

With v≅c, the modified Dirac equation will yield more accurate results, particularly compared with the Schrodinger equation. We also find that the equation λ=hc/βE is equivalent to the de Broglie wave equation, λ=h/p, provided we use the relativistic mass in the de Broglie equation. Given this, these equations yield accurate experimental results.

Thus we find that the modified formulation of de Broglie wave equation λ=hc/βE leads directly to a modified Dirac relativistic wave equation and is supported by recent experiments which measure the wavelength of matter and demonstrate the electron orbitals experimentally from these wave equations for matter.

Wave Particle Duality and Relativity

From here it is possible to proceed in several ways using the relativistic wave equation. It is apparent that the reintroduction of the term for relative velocity into the wave equations will enable the reintroduction of special relativity into quantum mechanics. In particular we should now be able to derive the term

$$\sqrt{( 1 - \frac{{v}^{2}}{{c}^{2}} )}$$

as a special case of quantum mechanics.

Thus if:

$$\begin{matrix}λ = hc / β E & \\ As E = \sqrt{{p}^{2} {c}^{2} + {m}_{0}^{2} {c}^{4}} , squaring & \\ {λ}^{2} = \frac{{h}^{2} {c}^{2}}{{β}^{2} \cdot ( {p}^{2} {c}^{2} + {m}_{0}^{2} {c}^{4} )} & \\ Conventionally {p}^{2} {c}^{2} = \frac{{E}^{2} {v}^{2}}{{c}^{2}} & \\ then & \\ {λ}^{2} = \frac{{h}^{2} {c}^{2}}{{β}^{2} \cdot ( ( {E}^{2} {v}^{2} / {c}^{2} ) + {m}_{0}^{2} {c}^{4} )} & \\ Thus as {β}^{2} = \frac{{v}^{2}}{{c}^{2}} and {m}_{0}^{2} {c}^{4} = {E}_{0}^{2} , then \text{:} & \\ {β}^{4} {E}^{2} + {β}^{2} {E}_{0}^{2} = \frac{{h}^{2} {c}^{2}}{{λ}^{2}} & \\ hence {β}^{4} {E}^{2} = {h}^{2} {c}^{2} \cdot \frac{1}{{λ}^{2}} - {β}^{2} {m}_{0}^{2} {c}^{4} thus & \\ {β}^{2} = \frac{{h}^{2} {c}^{2}}{{β}^{2} {E}^{2}} \cdot \frac{1}{{λ}^{2}} - \frac{{β}^{2} {m}_{0}^{2} {c}^{4}}{{β}^{2} {E}^{2}} & \\ As {E}^{2} = {m}^{2} {c}^{4} & \\ {β}^{2} = \frac{{h}^{2} {c}^{2}}{{β}^{2} {m}^{2} {c}^{4}} \cdot \frac{1}{{λ}^{2}} - \frac{{β}^{2} {m}_{0}^{2} {c}^{4}}{{β}^{2} {E}^{2}} & \\ Substituting h = {m}_{q} {c}^{2} & \\ {β}^{2} = \frac{{m}_{q}^{2} {c}^{6}}{{β}^{2} {m}^{2} {c}^{4}} \cdot \frac{1}{{λ}^{2}} - \frac{{β}^{2} {m}_{0}^{2} {c}^{4}}{{β}^{2} {E}^{2}} & \\ As {m}_{q} / {}^{′} m = 1 / {n}_{q} & ( eq . 2 ) \\ {β}^{2} = \frac{{c}^{2}}{{β}^{2} {n}_{q}^{2}} \cdot \frac{1}{{λ}^{2}} - \frac{{β}^{2} {m}_{0}^{2} {c}^{4}}{{β}^{2} {E}^{4}} & \\ Thus if f = {β}^{2} {n}_{q} ; & ( eq . 7 a ) \\ {β}^{2} = \frac{{v}^{2}}{{f}^{2}} \cdot \frac{1}{{λ}^{2}} - \frac{{β}^{2} {m}_{0}^{2} {c}^{4} {f}^{2}}{{β}^{2} {E}^{2}} & \\ As 1 / {λ}^{2} = {f}^{2} / {v}^{2} & \\ {β}^{2} = \frac{{v}^{2}}{{f}^{2}} \cdot \frac{{f}^{2}}{{v}^{2}} - \frac{{β}^{2} {m}_{0}^{2} {c}^{4} {f}^{2}}{{β}^{2} {E}^{2}} & \\ Thus & \\ {β}^{2} = 1 - \frac{{β}^{2} {m}_{0}^{2} {c}^{4}}{{β}^{2} {E}^{2}} & \\ As {E}^{2} = {m}^{2} {c}^{4} & \\ {β}^{2} = 1 - \frac{{m}_{0}^{2}}{{}_{}^{′}{m}{}_{}^{2}} & \\ Hence & \\ {m}_{0} / {}^{′} m = {( 1 - {β}^{2} )}^{1 / 2} & \\ Thus & \\ {}^{′} m = {m}_{0} / {[ 1 - \frac{{v}^{2}}{{c}^{2}} ]}^{1 / 2} & \end{matrix}$$

Thus this derivation now allows relativity as a universal case of the quintessential wave nature of matter.

The original premises on which special relativity was based were: that the speed of light is a constant and that all observers are equal. As the speed of light has dimensions of length and time but not apparently of mass, the relativistic change in mass is not accounted for. Using quintessence logically and directly accounts for the relativistic mass changes.

Moreover, relativity can be derived from the de Broglie equation, and visa versa, directly, thus linking relativity and quantum mechanics by taking into account the existence of quintessence mass.

Hence, it is now possible to derive the relativistic equations for mass and in turn for space and time from the quintessential wave equation, thus deriving special relativity as a universal case of quantum mechanics and thus uniting special relativity and quantum mechanics. This now allows a further understanding of the nature of space-time.

The Space-Time Lattice

The understanding of the true nature of space-time and how it is formulated in three dimensions of real space is crucial. To simply assume that space-time exists, and thence not to question the nature of that existence, denies a deeper understanding of the universe.

In order to understand the nature of space-time itself, at the quantum level a further look at the nature light and the photon is necessary. Since Einstein's description of light as a particle (the photon) and the description of the photoelectric effect, the standard picture of light as simply a wave can, no longer be applied. If light was to exist as a photon, it could not exist in one dimension, as ordinary waves do, it would need to be three dimensional, with the addition of time. Let us suppose, in this case, that a photon is a three dimensional helical ringlet of light, travelling in the x vector, and spinning around the x-axis. Conventionally this ringlet has a radius; r=λ/2π. The ringlet itself would be vibrating in the y and z vectors. The vectors x, y and z would represent the photon, the substance of which, would be travelling in the x direction and oscillating in the y and z vectors, which would represent oscillatory energy. This in turn would allow it to act as a wave, and create oscillatory electromagnetic fields.

It is important to re-examine space-time itself in this light, this would have one directional vector with two vector dimensions of energy, one of capacitance and one of electrical permeability, thus accounting for the well known constants of free space; the permittivity of free space (ε₀) and the permeability of free space (μ₀) respectively. The vector dimension of direction x, would be the direction of travel and those “quintessences” travelling in an outwardly direction would account for none other than the expansion of the universe. Three of these quintessences would naturally constitute three dimensional visible space-time. These constituents of space-time would interact with the generations of the other vector dimensions reciprocally. Thus one quintessence would sweep out one vector of permeability and one vector of permittivity, through which the other two quintessences could travel, and vica versa, creating a three dimensional space-time lattice.

The permittivity of free space, (ε₀) which is equivalent to capacitance, would as with capacitance plates, be determined by the effective separation between quintessences. The permeability of free space (μ₀) is in fact a force, measured as 4π×10⁻⁷ N/A², would result from the force produced by the vibration of quintessence and would be dependent on the density of quintessence. Hence these two parameters would be reciprocal and thus the product of these two would therefore be a constant, which is recognised as none other than the speed of light.

$$c = \frac{1}{\sqrt{{μ}_{0} {ɛ}_{0}}}$$

This space time lattice would in effect be created by quintessences travelling in all directions with a speed of c within the lattice. The quintessences of the space time lattice would in effect produce a non-static ether. A non-static ether is fully compatible with special and general relativity. Indeed such an ether explains how space time can be curved as in general relativity. Furthermore, the existence of a non-static ether, was espoused by Einstein in his University of Leyden lecture on general relativity of May 5, 1920. In Einstein's own words;

“According to the general theory of relativity space without ether is unthinkable.”

Recent evidence from a number of sources now strongly support the presence of this non-static ether, in the form of quintessence. An editorial from a major journal states “combined with other observations such as those of distant Supernova, the QMAP results corroborate the prevailing theory of inflation with the twist that the Universe is only one third matter (both ordinary and dark) and two thirds quintessence, a form of energy possibly inherent in empty space”.

If we take into account the existence of quintessence and as such a three dimensional space-time lattice, matter which is intrinsically made of constituents of charge would interact with this lattice to produce the effects of mass. Mass would be perceived as a result of matter (whose constituent particles appear to contain charge) interacting with this lattice directly due to the inhibition of motion by the lattice's electrical permeability and permittivity vectors, which would form the existence of complex space. These quintessences would in the direction in the y and z vectors produce small vibrations of the order of the Planck length (10⁻³⁵ m), whilst passing through the vectors of permeability and permittivity, thus producing the effects of mass.

The vibration would endow quintessence itself a (non rest) mass m_{q} equivalent, to the minimal mass of:
m_{q}=h/c²=7×373×10⁻⁵¹ kg·sec (1)

The presence and magnitude of Planck's constant (h) and especially the speed of light (c) is thus explained. Indeed, the speed of light

$$c = \frac{1}{\sqrt{{μ}_{0} {ɛ}_{0}}}$$

is not in itself a fundamental quantity.

As the energy equivalence formula is E=mc², the minimal mass of a single quintessence, would thus be the minimal mass, h/c², hence again:
m_{q}=h(μ₀ε₀)=h/c²=7.373×10⁻⁵¹ kg·sec (1b)
or
m_{q}c²=h (1c)

It is postulated by general relativity that the shape of space time itself can be altered, indeed the presence of the space time lattice now allows this to be altered by altering the density of quintessence. It is further clear that if quintessences underly the structure of the space-time lattice, they may also underly the structure of matter itself.

With regards a single quintessence, this passing through an energy vector of the space-time lattice would appear as a vibrating string. In a similar way to string theory, the conglomeration of these quintessences would produce the constituents of ordinary matter. Thus the general equation for the number of quintessences (n_{q}) in an object of mass (m) would be
m/m_{q}=n_{q}

The mass of the electron (mₑ) for example, would be directly determined by the number of quintessences in the electron, multiplied by the mass of quintessence.

Quintessence and Complex Space

Quintessence is postulated to constitute the fundamental nature of space-time. Three quintessences each travelling in their respective x vectors at 90° to each other would create three dimensional real space-time. These quintessences would in the direction in their respective y and z vectors produce small vibrations of the order of the Planck length (10⁻³⁵ m), this would create the vector dimensions of permeability and permittivity. The result would give space-time 9 dimensions of space as in superstring theory. However, unlike superstring theory the six hidden dimensions would not be “curled up so as to be so small as to be invisible” these six dimensions would be present in complex space. Thus, only three of these dimensions would represent ordinary three dimensional particulate space time i.e. three dimensional objects. The other six dimensions produced by the vibrations of quintessence would form complex space.

The mathematics of complex space, using imaginary √−1 or (j) numbers, is assumed in the standard formulation of the Shrodinger wave equation. Thus the presence of complex space is an integral part of quantum mechanics.

$$- \frac{{h}^{2}}{2 m} \cdot \frac{{ⅆ}^{2} ψ}{ⅆ {x}^{2}} + V ψ = j h \cdot \frac{ⅆ ψ}{ⅆ t}$$

The mathematics of complex space is also an essential and integral part of the principles and application of modern electronic and control engineering. Indeed it has been well recognised for some time that each direction vector in electronic engineering can, be associated with complex vectors.

As this complex space consists of the vectors of permittivity and permeability it would only be “felt” by charged particles as in the electron. Nevertheless, as all particles are fundamentally composed of charged particles the effects of complex space would be felt by endowing these particles with mass and in turn kinetic energy.

In conventional complex space, a 2 dimensional Cartesian Argand diagram is mathematically used. However, in order to formulate the equations for particles a three dimensional Argand diagram is essential. This will have three dimensional vectors, one real vector and two imaginary vectors. Three of these diagrams will be required to fully describe the nature of particles, each with a real vector in the x, y and z vectors, respectively. Nevertheless, in the instance below the real vector is the x vector and the two imaginary vectors are given by (ⱼy,ⱼz)

The Three Dimensional Argand Diagram

The beauty of a three dimensional Argand diagram is that the complex conjugate (i.e. the mirror image which confers mathematical reality on the coordinates) is formed by the value of the minus coordinate in the other complex vector dimension. Thus the complex conjugate of (Cₓ^{1/2}+ⱼc_{y}^{1/2}+₋ⱼc_{z}^{1/2}) is (cₓ^{1/2}+ⱼc_{y}^{1/2}+ⱼc_{z}^{1/2}). These two sums when multiplied thus give a real number solution.

Furthermore it is clear that nine dimensions of space time are necessary in the general relativistic equations. By including complex space we thereby create the nine dimensional spacial metrictensor and the metric energy tensor of matter necessary for computations for general relativity From here we can begin to understand the true structure of matter.

Energy and the Space-Time Lattice

The presence of numerous experimental data for quantum tunnelling. and indeed the recent observations by Nicholas Gisin, on the entanglement of distant photons now returns us to EPR experiments.

Using the quintessential modification of the de Broglie wave equation, gives us an insight into these teleportation and EPR effects.

As
λ=hc/βE (2)
and
E=hn_{q} (1a)
then
λ=c/βn_{q} (2b)

Importantly, as indicated by equation (2b), energy having no quintessence; would have a wavelength of infinity. Specifically pure energy containing no quintessences, would have a lambda of infinity. According to quantum mechanics an infinite wavelength would result in the probability of that energy being anywhere. As energy itself has no electrical charge it would not be impeded by the permittivity and permeability of the three dimensional space-time lattice. Moreover, energy would not be detectable in three dimensional space-time, unless it interacted with matter, as in the EPR experiments. Indeed, energy is not observed when not bound to any form of mass or particle. Thus equation 9d, takes us to our original assertion

Energy is Not Bound by the Space-Time Lattice

Thus, as the EPR experiments suggest the existence of energy separate from matter and thus separate from the three dimensional space-time lattice, it is interesting to find that experiment suggests the existence of free energy in a continuum separate from space time to produce the effects of quantum teleportation

This is not, however, teleportation across an additional dimension, this is a term to describe in partially familiar terms the dissociation of energy from the three dimensional space-time lattice. As time is inextricably linked to each dimension of space, the effects of energy would be inextricably linked to the events, such as the creation of virtual particles, we see interacting within space-time.

It is unlikely that observers have any direct day to day experience to explain quantum events. Nevertheless, quantum physics may have given us a window into the hitherto hidden workings of the Universe. Thereby, the mystery of the uniformity of the Universe, across distances which the speed of light could not apparently traverse, is readily explained by the fact that the free energy contained in the Universe is not bound by the space-time lattice.

In the case of light, due to the exceedingly small masses involved, there would be relatively easy exchange of matter with free energy within a photon. This would make the photon the ideal experimental tool to look for energy which is not bound by matter and in turn energy which is not bound in space-time. Indeed, very recently Furusawa et at. have reported to have observed the transference of energy as photons from A to B, without those photons traversing space-time. This finding which has been supported using other experimental techniques, is very important as it suggests the existence of such a quantum continuum.

We have already seen strong experimental data using photons, atomic spins and other data for quantum teleportation which have recently been published which support these findings. According to the above equations the teleportation would vary in a predictable fashion, as with photons, in line with the wavelength of the light used, relative to the size of vibration of quintessence. As regards matter, the results do confirm that the effect of quantum tunnelling is indeed dependant on the wavelength of matter and the size of that matter.

### Part II—Particle Physics

Electron Structure

Understanding the electron is fundamental to the understanding of the elementary particles. The hidden nature of the electron may recently have been revealed through observations by Horst Stormer, Daniel Tsui and Robert Laughlin for which a Nobel prize has recently been awarded. They describe a quasi electron particle of charge ⅓e. This has been described on a quantum basis as a vortex of energy, bound as a quasi particle in one dimension x, but not bound in the other two dimensions y and z, allowing dispersion in space-time as a vortex. What is more intriguing are the experimental conditions in which this occurs. First of all a two dimensional electron gas is created and held between two capacitance plates. A magnetic force is then applied in the remaining dimension, virtually creating a one dimensional passage through which only a quasi electron appears to be able to pass.

Given the presence of charge of ⅓e, then three of these quasi electrons could form an entire electron in three dimensional visible space time. Nevertheless, each would have energy and hence a wave function which would be present in the other vectors. This electron could thus follow the probability functions as described by the Shrodinger wave equation for ψ (otherwise termed as “essence” by Shrodinger)

If the mass of the electron (mₑ) is constituted from quintessence, using the formula:
mₑ/m_{q}=n_{q}

Then an electron would be constituted from:

$$\frac{9.11 \times {10}^{- 3} kg}{7.373 \times {10}^{- 51} kg \cdot sec} = 1.235 \times {10}^{20} quintessences \text{/} sec .$$

Thus taking into account the mass-energy content of quintessence (m_{q}) it is independently possible to derive the magnitude of the charge of an electron (e) using the following equation.

$$e = \sqrt{\frac{{m}_{q} {ɛ}_{0}}{( \frac{4}{3} ) π hc}} = 1.61 \times {10}^{- 19} C$$

This is in close agreement with the experimentally observed charge on the electron of 1.602×10⁻¹⁹ C.

Interestingly substituting m_{q}=h/3c² in the above equation we have:

$$e = \sqrt{\frac{{ɛ}_{0}}{3 ( \frac{4}{3} π {c}^{3} )}} \qquad ( 6 )$$

This can also be written as

$$e = \sqrt{\frac{{ɛ}_{0}}{3 ( \frac{4}{3} ) π {c}^{3}}} \qquad ( 6 a )$$

Equation (6) has a number of very special implications, if re-examined, firstly three of these quasi electron spheres appear to be required to constitute the charge of the electron. More intriguingly, it indicates that the charge is related to the volume of a sphere with an apparent radius of c. Thirdly it indicates that the square of the charge of an electron (e) is proportional to the permittivity of free space (so). The charge given from equation (3) is in close agreement with the measured charge of the electron. Furthermore a more exact value for the charge of the electron (to seven decimal places) can be deduced by taking into account the gravitational field of the Earth (see Gravity and the Charge of the Electron). Furthermore the charge of the electron (e) can now be derived from first principles. Thus, equation (3) corroborates the evidence that the electron is indeed composed of three quasi electrons in keeping with recent experimental findings.

The significance of the electron, composed of three spheres each with a radius of c, is not immediately clear, but can be understood if the frequency of rotation of the electron is taken into account. Thus if the diameter of the electron was approximately 10⁻¹⁹ m, then its spin would need to be

$$\frac{1}{c} \times {10}^{- 15}$$

m approx. eq. 10⁶ cycles/sec. Thus given a very high rotation rate an electron could have an effective radius of 1/c and still occupy subatomic sizes. Indeed these observations might be used to estimate the rate of rotation of the quasi electron and its size (see Appendix 1).

With regards a single quintessence, this passing through an energy vector of the space-time lattice would appear as a vibrating string. In a similar way to string theory, the conglomeration of these quintessences would produce the constituents of ordinary matter. The electron, for example, would be constituted from approximately 1.235×10²⁰ quintessences.

The dimensions of the equation for the electron can be readily resolved by considering each of the three vector dimensions. The exact dimensions of the equation need to be considered in the light of the nature of space-time itself. These dimensional equations help explain the nature of matter. Indeed the equation for the electron may be necessary for the full understanding of gravity

Complex Space and Electron Structure

The presence of complex space also now further explains the conformation of the electron, and its formulation at the quantum level, and the presence of particles, anti-particles and their spin up and spin down characteristics.

Indeed the short form equation for the charge of the electron (−e) can now be rewritten as a metric tensor with three dimensions in real space and six in complex space.

Thus if three of the x, y and z vectors are in real space and six vectors in complex space, where c is the speed of light in the real space vector, ⱼc is the speed of light in the complex vector and ₋ⱼc is the complex conjugate of ⱼc, thus the electron can be mathematically represented by the equation:

$$- e = {ɛ}_{qe} / {( \frac{4}{3} π )}^{1 / 2} \cdot \begin{matrix} {( {c}_{x} )}^{1 / 2} \cdot {( {jc}_{y} )}^{1 / 2} \cdot {( - {jc}_{z} )}^{1 / 2} \\ + + + \\ {( - {jc}_{x} )}^{1 / 2} \cdot {( {c}_{y} )}^{1 / 2} \cdot {( {jc}_{z} )}^{1 / 2} \\ + + + \\ {( {jc}_{x} )}^{1 / 2} \cdot {( {jc}_{y} )}^{1 / 2} \cdot {( {c}_{z} )}^{1 / 2}\end{matrix}$$

Which now elegantly gives the real number solution

$$e = \frac{{ɛ}_{qe}}{3 \sqrt{( \frac{4}{3} ) π {c}^{3}}}$$

Where e=ε_{qe} is given as the permittivity of free space for a single quasi electron Equation 4 represents a “complex” tensor

Whilst the two dimensional Argand diagram has four quadrants, the three dimensional Argand diagram has eight cubic sectors. Two of these cubic sectors are diametric opposites and can represent “real” particulate objects. These have the primary coordinates x, y, −z; as in the electron described above, and the −x, −y, z, with the real vector x now having a minus sign. These two “real” cubic sectors, therefore, mathematically represent particles and their anti-particles.

The mathematical presence of the two primary diagonal mirror images (x, y, −z and −x, −y, z) now allow the introduction of the concept of antiparticles. This extension of the maths into a three dimensional Argand diagram thus results in the automatic formulation of the maths of antiparticles. Thus the charge of the positron (⁺e) is formulated by the shortened form equation, where the real vectors now each have the minus sign, and therefore exist in the −x, −y, z sector of the three dimensional Argand diagram.

$$e = {ɛ}_{qe} / {( \frac{4}{3} π )}^{1 / 2} \cdot \begin{matrix}- {c}_{x}^{1 / 2} {\cdot }_{- j} {c}_{y}^{1 / 2} {\cdot }_{j} {c}_{z}^{1 / 2} \\ {}_{j} {c}_{x}^{1 / 2} \cdot - {c}^{1 / 2 y} {\cdot }_{- j} {c}_{z}^{1 / 2} \\ {}_{- j} {c}_{x}^{1 / 2} \cdot {jc}_{y}^{1 / 2} \cdot - {c}_{z}^{1 / 2}\end{matrix}$$

The three dimensional Argand diagram also accounts for chirality and indeed the up and down spin of the electron. There are two other “real” primary coordinates in the Argand diagram, these are themselves the partial mirror images of the above coordinates (i.e. x, −y, z and −x, y, −z). In particular the y axis is of the opposite sign, thus in particles the y axis is in the downward direction, to form down spin particles and in anti-particles in the up direction, to form the antiparticle The up spin electron is given by eq. 8 and hence the down spin electron (−e|↓≦) is given by the equation

$$- el ↓ 〉 = {ɛ}_{qe} / {( \frac{4}{3} π )}^{1 / 2} \cdot \begin{matrix}{c}_{x}^{1 / 2} {\cdot }_{- j} {c}_{y}^{1 / 2} {\cdot }_{j} {c}_{z}^{1 / 2} \\ {}_{j} {c}_{x}^{1 / 2} \cdot {c}^{1 / 2 y} {\cdot }_{- j} {c}_{z}^{1 / 2} \\ {}_{- j} {c}_{x}^{1 / 2} \cdot {jc}_{y}^{1 / 2} \cdot - {c}_{z}^{1 / 2}\end{matrix} \qquad ( 9 )$$

Thus the three dimensional Argand diagram accounts directly for the presence of antiparticles and the spin up and spin down particles seen in nature. It also accounts for the necessity of the electron to form a square root spherical object, as complex space depends on √−1, otherwise known as j.

Electron Pairing and Superconductivity

As the quintessences making up the electron are in a square root conformation, each of these quasi electrons would have a tendancy to pair to form an entire sphere.

The square root sphere structure of electrons with up and down spins can now superimpose to produce a complete sphere of varying extents. This produces electron pairing as seen at the atomic and molecular levels. It also accounts for the Pauli exclusion principle. This pairing thus accounts for the reactivity of the valence electrons and the electron probability densities, which in turn accounts for the existence of chemistry.

Furthermore, it is possible to account directly for superconductivity from first principles. For if both the complex and real vectors of the electron combine completely, the product of an up and down spin electron form a perfect superimposed sphere with radius c, with a charge of 2.59×10⁻³⁸ C, denoted by the formula:

$${e}^{2} = \frac{ɛ ο}{3 ( \frac{4}{3} π {c}^{3} )} = 2.59 \times {10}^{- 38} C \qquad ( 6 b )$$

As with standard superconducting theory, superconductivity can be explained by the formation of “Cooper” electron pairs, where the electrons are forced to pair by the presence of positive crystal charge in particular formation, at supercooled temperatures. In addition the electron pair now forms a stable entity whose angular momentum cancels.

It additionally becomes clear that the charge of two separate electrons (2e) is 3.2×10⁻¹⁹ C, but the charge of the combined electrons (e²) is 2.59×10⁻³⁸ C. This electron pair thus appears to have 19 orders of magnitude less charge than the electron and in turn 19 orders of magnitude less resistance. It is this effective reduction in charge and in turn resistance, which may account for superconductivity. When observed directly any electrical interaction with the Cooper electron pair will, however, result in the release of the full charge of both electrons, so that the full electrical charge put in will be equal to that coming out of the apparatus.

The Fine Structure Constant

Intruiginty from our knowledge of the electron we can further define the term .alpha., the fine structure constant; from the structure of the electron. Thus as the standard term

$$α = \frac{{e}^{2}}{hc \times 47 π {ɛ}_{0}} ;$$

substituting the term

$$\begin{matrix}{ⅇ}^{2} = \frac{{ɛ}_{0}}{3 ( 4 / 3 ) π {c}^{3}} & ( eq . 6 ) \\ and & \\ h = {m}_{q} {c}^{2} & ( eq . 1 )\end{matrix}$$

we find:

$$\begin{matrix}\frac{2 π}{α} = {{m}_{q} [ 3 ( 4 / 3 π {c}^{3} ) ]}^{2} \\ {}^{*} or \\ \frac{2 π}{α} = \frac{{m}_{q} {ⅇ}^{4}}{{ɛ}_{0}^{2}}\end{matrix}$$

For brevity we may represent the quasi electron structure as (4/3)πc³=θ; to signify its threefold symmetry, thus

$$\frac{2 π}{α} = {{m}_{q} ( 3 θ )}^{2} \qquad ( 10 )$$

Indicating that the fine structure constant of the electron (a) is indeed related to its dimensional structure. Again taking into account the effects of gravity the fine structure constant can be derived from first principles to nine decimal places (see Gravity and the Charge of the Electron).

Fundamental Forces and Particle Structure

In order to understand the fundamental forces and the nature of fundamental particles, an overview is required. Thus, there are three major forces; strong, electro-weak and gravity, each mediated by three force particles the gluon, photon and graviton respectively. These in turn, influence three types of particle, the quark, lepton, and by general relativity space-time itself. Each of these are composed of particles with multiples of charge of ⅓, which are themselves in three generations, and are present in three dimensions of real space. It is important that a comprehensive view of nature explains this threefold symmetry.

Using the Standard Model of particles, it is well accepted there exist quark particle charges of −⅓, −⅔ and +⅓ and +⅔ in quarks and anti-quarks. Given that each particle is made up of three quarks the presence of these fractional charges support the association of the fractional charges in this way to form three dimensional charged particles. In stable particles each of the three quarks would have a vector in one dimension, giving the three quarks together an existence in three dimensional visible space time. The particles that bind the quarks (gluons) are themselves required, in stable particles, to have three different color charges, one color in each dimension, for the particle to exist in three dimensional space-time. Furthermore, there are three generations of quarks (and indeed leptons).

The Standard Model (or a modification of this) and in particular the observation of quarks and indeed quasi electrons with fractional charge of ⅓ and ⅔ in both cases, indicates that particles are constituted from the equivalent of three of these quasi particles to form an electron and quarks to form baryons. In the normal three dimensions the energy would be carried by the particle, However, because each particle is constituted of three quasi particles and in each quasi particle or quark one visible dimension would be the direction vector, in the other two hidden dimensions of each vector the waves would carry energy. Thus each particle would be associated with vibration, which would account for wave particle duality and Heisenberg's uncertainty principle in three dimensional visible space-time.

These observations lead us directly to the previous postulate that the structure of the electron is composed of none other than three (root) spheres, and that this equation for the electron allows the determination of the charge of the electron from first principles, thus:

$$e = \frac{ɛ {0}^{2}}{[ 3 ( 4 / 3 π {c}^{3} ) ]} \qquad ( 6 )$$

In addition the mass of the proton (mₚ) can be directly calculated from the ratio of the mass (mₑ) of the electron, given by the equation:

$$\frac{{m}_{e}}{{m}_{p}} = 5.45 \times {10}^{- 4} = 3 \frac{π}{\sqrt{c}} \qquad ( 11 )$$

Strictly we should write,

$$\frac{{m}_{e}}{{m}_{p} + {m}_{e}} = 3 π \sqrt{c} ;$$

which is much more elegant.

Which now gives

$$\frac{{m}_{e}}{{m}_{p}} = \frac{1}{\sqrt{c} / 3 π - 1} = 5.4462 \times {10}^{- 3}$$

This is in very close agreement with the experimentally derived ratio of the proton to electron masses which is also; 5.4462×10⁻³

Thus the correlation factor between theory and experiment has a maximum error <0.00001.

If we combine equation 3:

$$e = \sqrt{\frac{{ɛ}_{0}}{3 ( 4 / 3 ) π {c}^{3}}}$$

and equation 13:

$$\frac{{m}_{e}}{{m}_{p}} = 3 \frac{π}{\sqrt{c}}$$

the positive charge of the proton (eₚ) is given by:

$${e}_{p} = \sqrt{\frac{{ɛ}_{0}}{3 ( 4 / 3 ) π {c}^{3}}} \times {m}_{e} \times 3 \frac{π / \sqrt{c}}{{m}_{p}} = e \qquad ( 12 )$$

The stable nuclear proton conformation can thus be represented by the short form equation:
p=3⁺\sqrt{3(4/3)πc³}×3(π/\sqrt{c}) (13)

This forms a stable 3×3 conformation as with the stable electron structure.

Importantly the term (π/\sqrt{c}) is the 90° solution to the Shrodinger wave equation for an electron confined in a space with radius c!.

Thus the standard equation for an electron confined in a one dimensional box is given by:

$$Eψ ( x ) = - \frac{{h}^{2}}{2 m} \frac{{ⅆ}^{2} ψ ( x )}{ⅆ {x}^{2}}$$

If the one dimensional box has a length 2L the quantum amplitude (A) can only be non zero between x=0 and X=2L and the standard solution for the amplitude is none other than:
A=(1/L^{1/2})

Thus in one dimension the standard solution to the Shrodinger wave equation is:
ψ(x)=(π/L^{1/2})Sin x/L

Thus not only is the electron charge derived from the equation for three spheres each with a radius of c (eq. 3); but the proton mass and charge can also be derived from the standard solution to the Shrodinger wave equation for a an electron confined in a space of radius c!.

The term (π/c^{1/2}) itself would thus most logically represent the gluon which is present in the proton. These gluons would bind the quasi electrons together to form the fundamental particles

The masses of all the known particles, including the up and down quarks, the W boson, the muon, charm, strange, the tauon, truth and beauty can thus also be derived from first principles in this fashion, and have the quasi electron as their basic constituent particle (see Appendix 1).

Thus the structure of the muon (μ) can also be derived from the ratio of the mass of the electron (mₑ) and the mass of the muon (m_{μ}):
mₑ/m_{μ}=4.7×10⁻³=c^{1/3}
Thus
μ=ε₀^{1/2}×mₑ/m_{μ}×3⁻(4/3=πc³)^{1/2}×(π/c^{1/3})

Where the charge of the muon is in this equation equivalent to that of the electron e. In this case (π/c^{1/3}) can be considered to represent a specific high energy photon. Thus the structure of the muon, written in short form is:
μ=3⁻(4/3πc³)^{1/2}×(π/c^{1/3}). (14)

Moreover the structure of the tauon can be calculated from the ratio of the mass of the electron and that of the Tauon (1.79 Mev);

Thus
0.511 Mev/1.79 Gev=2.85×10⁻⁴
mₑ/mᵣ=(π/c)^{1/3}×(π/c)^{1/9}=2.85×10⁻⁴

As the charge of the tauon is equivalent to the charge of the electron, hence the structure of the Tauon is given by the above equation
e_{τ}=ε_{qe}×(mₑ/m_{τ})×3⁻(4/3πc³)^{1/2}×(π/c)^{1/3}×(π/c)^{1/9}=e

This equation accurately predicts the charge −1; and mass of the Tauon (.˜1.78 Gev). Thus the structure of the Tauon can in short form be given by the equation
τ=−3(4/3πc³)^{1/2}×(π/c)^{1/3}×(π/c)^{1/9} (15)

Furthermore a more exact value for the mass of the muon and tauon can be deduced by taking into account the gravitational field of the Earth in a similar way to identifying the exact charge of the electron. In addition it may be necessary to take into account a possible mass value of the neutrino to arrive at a precisely accurate mass value of the muon and tauon. Nevertheless, the mathematical proof of these short form equations lies in the fact that they can very closely identify the charge and the masses of these particles, from first principles, as in equations.

Overall the mathematical geometrical structure of all the particles can be derived from the quasi electron, which is in turn derived from quintessence. Thus, the short form particle structures can now be derived from first principles. This includes the quasi electron (qe) and electron (e), from which the quarks (u,d) and in turn the stable proton (p) and stable neutron (n) and alpha particle (a) respectively are derived. The general structure of the force carrying bosons the photon. (g) and the gluon (γ) and the intermediate vector boson (W) can be given. It will also intriguingly be possible to derive, according to their generation, the structure of the strange (s) charm (c), beauty (b, or bottom) and truth (t or top) quarks directly from the structure of the muon (μ) and Tauon (τ) respectively.

Using the term Θ=(4/3πc³), where, −/+ represents the charge of the quasi electron, we find:

1st Generation:
(qₑ)=⁻Θ^{1/2} (6c)
e=3^{-1/2} (6)
d=⁻Θ^{1/2}·3(π/c^{1/2}) (16)
u=2⁺Θ^{1/2}·3(π/c^{1/2}) (17)
s=⁻Θ^{1/2}·3(π/c^{1/2}) (18)

2nd Generation
μ=3⁻Θ^{1/2}·(π/c^{1/3}) (14)
c=2⁺Θ^{1/2}·(π/c^{1/3})·(π/c^{1/4}) (19)
b=⁻Θ^{1/2}·(π/c^{1/9})·(π/c)^{1/4} (20)

3rd Generation
τ=3⁻Θ^{1/2}·(π/c)^{1/3}·(π/c)^{1/9} (15)
t=2⁺Θ^{1/2}·(π/c)^{1/3}·(π/c)^{1/9}·(π/c)^{1/4} (21)

Particle Gluons (g):
g₁=(π/c^{1/2}) (22)
g₂=(π/c)^{1/2} (22a)
g₃=(π/c^{1/4}) (22b)
g₄=(π/c)^{1/4} (22c)

Particle Photons (.gamma.):
γ₁=(π/c^{1/3}) (23)
γ₂=(π/c)^{1/3} (23a)
γ₃=(π/c^{1/9}) (23b)
γ₄=(π/c)^{1/9} (23c)

Intermediate Vector Boson (W^{+/-}):
W⁺=3⁺Θ^{1/2}·2(π/c^{1/6})⁶ (24)
W⁻=3⁻Θ^{1/2}·2(π/c^{1/6})⁶ (25)

Stable* Proton:
p=3⁺Θ^{1/2}·3(π/c^{1/2}) (13)

Stable* Neutron:
Stable * Neutron:

$$n = \begin{matrix}{}^{+} Θ {↓}^{1 / 2} \cdot 2 ( 3 π \text{/} {c}^{1 / 2} ) {\cdot }^{-} Θ {↑}^{1 / 2} \\ {}^{+} Θ {↓}^{1 / 2} \cdot 2 ( 3 π \text{/} {c}^{1 / 2} ) {\cdot }^{-} Θ {↑}^{1 / 2} \\ {}^{+} Θ {↓}^{1 / 2} \cdot 2 ( 3 π \text{/} {c}^{1 / 2} ) {\cdot }^{-} Θ {↑}^{1 / 2}\end{matrix}$$

* Stable nucleonic neutron and proton conformations differ slightly from the Standard Model, this is due to the sharing of quasi electron and quasi positron particles within the nucleus, which allows stabalisation of these particles by the formation of stable 3×3 structures. The Standard conformations which describe non-nucleonic neutrons and protons are additionally given in Appendix 1.

Alpha particle (α):

$$Alpha particle ( α ) := α = \begin{matrix}[ {3}^{+} Θ ] {↓}^{1 / 2} \cdot 2 ( 3 π \text{/} {c}^{1 / 2} ) \cdot [ {3}^{-} Θ ] {↑}^{1 / 2} \\ [ {3}^{+} Θ ] {↑}^{1 / 2} \cdot 2 ( 3 π \text{/} {c}^{1 / 2} ) \cdot [ {3}^{-} Θ ] {↓}^{1 / 2} \\ [ {3}^{+} Θ ] {↓}^{1 / 2} \cdot 2 ( 3 π \text{/} {c}^{1 / 2} ) \cdot [ {3}^{-} Θ ] {↑}^{1 / 2}\end{matrix} \qquad ( 27 )$$

The mathematical proof for these structures and their decay mechanisms is lengthy and is thus fully contained in Appendix 1. All the particle structures are accurately mathematically defined by the masses of these particles.

The structure of these particles all contain the quasi electron and thus the metric tensor structure necessary in the formulation of the gravitational equations is sustained. The respective forces created by the gluon and the photon are important as they tell us the behaviour of matter and also lead to the likely structure of the graviton

Particle Spin and Size

The significance of the electron, composed of three spheres each with a radius of 1/c, is not immediately clear, but can be understood if the frequency of rotation of the electron is also taken into account. Knowing the structure of the electron has led us to deduce its charge and thus may lead us estimate its size and spin. Thus these observations might be used to calculate the radius and rate of rotation of the electron.

Let us suppose, that nature is truly beautiful, and that the radius of the fundamental quasi electron is indeed 1/c, and in turn the radius was balanced by the velocity of rotation 2π/c. This can be directly confirmed mathematically by taking into account the known spin of the electron, h/4π. Thus the actual spin of the electron may be calculated form the known energy of the spin.

The radius of the electron is not up till now known, but the radius of a quark has been estimated, and this is the radius derived from deep inelastic collisions of the proton. These estimates reveal a radius of approx. rₚ=1.18×10⁻¹⁵ m This value may be used to assist in confirming the spin of the proton in revolutions per sec. (revs) and in turn the spin and size of the electron. Firstly we may proceed to estimate the spin of the proton. Thus as h=E·t (Joules×sec) and h=E·t=F·d·t (Joules×sec), then the spin;
h/4π=F·d·t (28)

As F=ma, where α=(revs·2π)²rₚ and m=the mass of the proton, then
h/4π=m(revs·2π)²rₚ·d·t

The actual distance (d) traveled in a circle of half integer spin in 1 second is: revs·πrₚ thus:
h/4=m(revs·2π)³rₚ²/2

Hence:
revs=[h/m(2π)⁴rₚ²]^{1/3}

Taking the effective mass the proton as 1.6726×10⁻²⁷ kg, then the rate of spin of the proton in revolutions/sec is:
revs=5.65×10⁶ cycles/sec

From the frequency of the specific rotation of the proton, given the half integer spin associated with the proton, we can thus mathematically confirm the relationship between the radius of a particle and its spin:
rₚ×revs/2=1/c (29)

Furthermore, the fundamental radius of 1/c seen in geometric structure the quasi electron, is also reflected in the rotation rate and radius for the proton, thus as above 1/c÷½ revs=1.85×10⁻¹⁵ m. Moreover, this means the actual half integer velocity of rotation is none other than 2π/c in metres/sec. So that the particle is in harmonic balance.

Using the fundamental formula h/4π=F·d·t, it is possible to obtain accurate estimates of the radius and spin rates of the electron, or indeed any particle, using the same principle of harmonic balance. Using the formula:
revs=[h/m(2π)⁴rₑ²]^{1/3}

It appears there are two unknowns, the radius if the electron and its revolution rate, however, in accordance with the equation, rₚ=2/c.revs, which gives the revolution rate of the proton, the same principle may also be used for the electron, by substituting rₑ=2/c.revs, such that:
revs=hc²/4mₑ(2π)⁴ (30)

Taking the mass of the electron 9.109382×10⁻³¹ kg, the rate of revolution of the electron is:
revs=1.048×10¹⁰ cycles/sec

Which gives a predicted radius of the electron as
rₑ=6.336×10⁻¹⁹ cycles/sec

So the half integer rotation velocity (revs.πr) is 2π/c !, for the electron in keeping with the harmonic balance of the electron.

The same principle may be used to obtain an accurate estimate of the spin and radius of the muon, or any other particle. Using the above formula
revs=hc²/4mₑ(2π)⁴ (31)

Then as the mass of the muon is 1.8823×10⁻²⁸ kg then the revs of the muon f_{μ}=5.070×10⁻⁷ cycles/sec and the radius r_{μ} is thus 1.316×10⁻¹⁶ m.

It is now possible to begin to explain how the muon and the other subatomic particles are formed. If a quasi electron is complexed with another structure the total geometric structure needs to maintain harmonic balance. So the frequency of rotation would need to match geometric structure with which the quasi electron was complexed

Intriguingly we find asymptotic convergence for the formulas for frequency and mass occurs, when the geometric structure complexed with the quasi electron has the structure represented by (π/c^{1/3}) [giving the frequency divided by two, because the single integer spin of the force carrying particles compares to a half integer spin for the muon]. So that
(fᵣ3π/2)^{1/3}=f_{μ}

When the ratio of the masses of the electron (mₑ) and muon (m_{μ}) are related, such that:
mₑ(3π/c^{1/3})=m_{μ}

Indeed we find that (allowing for the neutrino) this ratio is very close to the actual ratio of the mass of the electron to the mass of the muon, determined experimentally.

Furthermore, we have seen that these geometric structures, representing harmonics of the speed of light, which either match the frequency or the amplitude of vibration of the quasi electron, mathematically define the masses of the particles and the fundamental forces of Nature.

### Part III—Quantum Gravity

Quantum General Relativity

Given the overall energy “complex” energy tensor structure of the electron and the metric tensor, assumed in general relativity, the quantum nature of gravity itself can now be explored. The spherical complex tensor for the electron and the positron give the mathematical quantum structure and energy tensor for all the other particles. Together with the time dimension these nine space dimensions account for the 10 parameters present in the metric tensor necessary to formulate the equations for gravity using Riemann geometry and thus forms the basis of quantum gravity. Intriguingly the metric tensor at each point in space time is required to consist of a collection of ten numbers, Consequently, ten dimensional space-time hypotheses, such as this or superstring theory, do automatically yield general relativity.

Furthermore, the mathematical representation of the graviton and the gravitational constant may be directly estimated from the knowledge of the mass and radius of quintessence. Thence, the force of the vibrations of quintessence lead directly to quantum gravity.

The radius of quintessence should be approximately in keeping with the Planck length estimate (r), which is conventionally derived from the standard dimensional equation:
r_{q}²≅Gh/c³ (32)

Given the nine spacial parameters present in the metric tensor, used in general relativity we find that the actual formula for r_{q}² is mathematically in agreement with theory when:
9r_{q}²=Gh/c³ (33)

This again supports the 9 dimensional view of space and the size of the vibrations of quintessence can thus be estimated.
r_{q}=1.35×10⁻³⁵ m (33a)

This value is in agreement with the Planck length. Indeed if the above equation is correct then we find that we can derive the standard equation for the general relativistic increase in radius, r′, (eq. 34) directly from first principles and arrive at a more fundamental equation for quantum gravity. As
r′=G·M/3c³ (34)

By substituting eq. 33) into equation 34, a fundamental relationship between r′ and M is obtained.
r′/3r_{q}²=GMc³/Ghc³=Mc/h

And substituting the quintessential equation, h=m_{q}c² (eq. 1) then:
r′/3r_{q}²=M/m_{q}c=n_{q}/c (35)

Hence the ratio of the change in radius to that of the radius of quintessence squared, is proportional, by a factor of c, to the ratio of the mass M of an object to that of the mass of quintessence, effectively the number of quintessences. Thus the change in radius, r′ due to gravitation, is related to none other than the ratio of the mass and radius of an object to the mass and the square of the radius of quintessence. Thus again the gravitational change in radius is directly related to the number of quintessences.

Naturally, this would be exactly what would be logically expected if quintessence, like the equation for the charge of the electron (eq. 6) forms from a root sphere. Thus the change in spacial radius of a normal sphere is dependant on the square of the quintessential radius.

This increase in apparent radius represents none other than the (gravitational) binding energy for quintessence.

The meaning of the above dimensional equation (33) might itself be further understood by substituting the mass of quintessence (where m_{q}=h/c²) into the equation. Thus in nine dimensions the gravitational constant (G) may be more logically given as,
9(πr_{q}²/m_{q})=Gπ/c (36)

Where πr_{q}² is the cross sectional area of quintessence and m_{q} is the effective mass of quintessence, and thus (πr_{q}²/m_{q}) represents the effective mass per unit area which quintessence exerts. This equation reduces to:
9r_{q}²/m_{q}=G/c (37)

From this we may derive the standard general relativistic relationship for the apparent change in radius (r′) around a mass (M), from an understanding of the mass m_{q} and number (n_{q}) of quintessences. As m_{q}=M/n_{q}, then:
3r_{q}²=G·M/3c·n_{q} (38)

Then if
n_{q}=r′c/3r_{q}² (39)

thus directly substituting for n_{q} in eq. 38:
r′=G·M/3c² (34)

The importance of this is that the gravitational change in radius now logically derives from equation 36, which describes the gravitational force as resulting directly from the mass of quintessence exerted/per unit area of quintessence.
9(πr_{q}²/m_{q})=G·π/c (36)

Thus equation 34 is the conventional equation for the general relativistic increase in radius (r′) in a gravitational field, which is here derived from the underlying nature of quintessence. Thus the gravitational constant is derived from the mass and radius of vibration squared of quintessence from first principles.

Indeed it is apparent that a more fundamental equation for gravitation now exists, for equation (39) is mathematically accurate and numerically agrees with eq. 34:
r′/3r_{q}²=n_{q}/c (39)

These equations may be readily mathematically verified. If in accordance with standard general relativity, the apparent increase in radius r′ is:
r′=GM/3c² (34)

Then given that the mass of the Earth is 5.9745×10²⁴ kg;
r′=1.478×10⁻³ m

Accordingly if r′=3r_{q}²·n_{q}/c; (eq. 39). Given the number of quintessences n_{q} constituting the Earth is M_{E}/m_{q}, then
n_{q}=5.9745×10²⁴/7.3725×10⁻⁵=8.104×10⁷⁴

As r_{q}²=1.823×10⁻⁷⁰ (eq. 33a) then:
r′=1.478×10⁻³ m

Thus equation 39 gives the same answer as the standard equation and may be understood on a logical basis. Indeed the meaning of c in the equation may be understood as it has been previously shown as being the basis for the radius of matter (eq. 6). Hence the general relativistic change in radius, r′, is none other than the effective binding energy for quintessence.

Quantum Gravity and Wave Particle Duality

Quantum gravity can now be readily linked with quantum mechanics, indeed any observations which are self consistent must be able to do so easily.

The frequency of light has been previously derived
f=E/h=n_{q}

Thus the formula for the frequency of light (E=hf) has previously been explained theoretically by the simple observation that the frequency is determined quite directly from the number of quintessences (n_{q}) within the photon. The same principle has also been shown to apply to matter.

Let us now follow these equations for matter by calculating the wavelength of a photon from the Gravitational constant as an example; and also as a test of these observations and to demonstrate that the gravitational equations can also apply to the quantum world.

If
n_{q}=r′c/3r_{q}² (39a)

where r′ is the general relativistic increase in radius, and r_{q} is the radius of quintessence (eq. 33). Where f=E/h=n_{q}, substituting for n_{q}, then the frequency of the photon f_{γ}(where β=1) is given by:
f_{γ}=r′c/3r_{q}²

Using the standard equation, r′=GM/3c² (eq. 34); we may substitute for r′, thus we have:

$$\begin{matrix}{f}_{γ} = GM \text{/} 9 {r}_{q}^{2} c 15 Thus \\ {f}_{γ} = \frac{G}{9 {r}_{q}^{2} {c}^{3}} \cdot {m}_{γ} {c}^{2} and as E = {m}_{γ} {c}^{2} ; & \\ {f}_{γ} = \frac{GE}{9 {r}_{q}^{2} {c}^{3}} \\ Indeed as 9 {r}_{q}^{2} = Gh / {c}^{3} , then {f}_{γ} = E / h = {n}_{q} & ( 40 )\end{matrix}$$

It is possible to also demonstrate that the same relationship holds for the wave equation for matter. If we take the relativistic wave energy of matter, which has been previously derived,
f=β²n_{q}

This includes the term for the number of quintessences flowing through the electron, in the complex vectors of space-time, to give the relativistic electron momentum (p) and a term for the rest mass, thus substituting into (40)

$${f}_{γ} = \frac{GE}{9 {r}_{q}^{2} {c}^{3}} \qquad ( 40 )$$

As f=β²n_{q} for matter then the equation expands to:

$$\begin{matrix}{f}_{m} = \frac{G}{9 {r}_{q}^{2} {c}^{3}} \cdot {β}^{2} E As λ = v / f , then & \\ λ = \frac{9 {r}_{q}^{2} {c}^{3} v}{G {β}^{2} E} & ( 41 )\end{matrix}$$

Then the equation again reduces to:

$$G = \frac{9 {r}_{q}^{2} {c}^{4}}{λ β E} \qquad ( 3 )$$

Equations 3, 40 and 41 are important as they show that the quantum wavelength of any particle of rest mass m can be derived from the gravitational constant G. Thus linking quantum mechanics to quantum gravity.

It is therefore important to confirm the numerical accuracy of the above equation (40). We can do this by comparing the result to the standard computation of the de Broglie equation, in a range where de Broglie itself is likely to be most accurate; which according to these observations is in the low energy range (see section on Wave Particle Duality).

If we take an electron with an energy of 0.1 KeV the wavelength is conventionally given (where the kinetic energy of the electron Eₖ is given by the product of the charge of the electron (C) and the potential applied eV=0.1 Kev), by the standard equation:

$$\begin{matrix}λ = h / p = h / {( {E}_{k} \cdot 2 {m}_{0} )}^{1 / 2} thus \\ λ = 6.63 \times {10}^{- 34} / {[ 1.602 \times {10}^{- 19} \times 1 \times {10}^{2} \times 18.22 \times {10}^{- 31} ]}^{1 / 2} \\ hence \\ λ ≅ 1.23 \times {10}^{- 10} m Using & \\ λ = \frac{9 {r}_{q}^{2} {c}^{4}}{Gβ E} Where E = γ {m}_{0} {c}^{2} & ( 3 a )\end{matrix}$$

At 0.1 Kev, electron velocity is 6×10⁶ r/sec, thus β=2×10⁻² and γ=1/(1−v²/c²)^{1/2}=1.0002. Thus:

$$γ = \frac{9 \times 1.82 \times {10}^{- 70} \times 80.78 \times {10}^{32}}{6.76 \times {10}^{- 11} \times β \times 1.0002 \times 9.11 \times {10}^{- 31} \times 8.998 \times {10}^{16}}$$

$$λ = 1.21 \times {10}^{- 10} m$$

Divergence between the de Broglie equation and the above equation (2) occurs at intermediate and high energies where it is generally accepted that the standard de Broglie equation may be less accurate. The values for eq. 2 and de Broglie are compared to recent experiments, which demonstrate a relativistic curvilinear plot for wavelengths of matter in keeping with eq. 40.

The de Broglie equation in the non-relativistic format yields a simple log/linear scale, which is not in keeping with relativity; whereas eq. 3 is dependent on relativity and mathematically accounts for both relativity in calculating the wavelength. Indeed recent experiment on quantum tunnelling through a wire mesh strongly suggests that the relationship between energy and wavelength is relativistically curvilinear^{(ref 1)}. Furthermore equation 3a suggests a fundamental relationship between energy (E), relative velocity (v/c=.β), gravity (G) and the quantum wavelength (λ)

$$\begin{matrix}λ = \frac{9 {r}_{q}^{2} {c}^{4}}{Gβ E} Indeed {as }^{9} {r}_{q}^{2} = Gh / {c}^{3} , then & ( 3 a ) \\ λ = hc / β E & ( 2 )\end{matrix}$$

Equation 2 is the very same as the Universal wave equation derived form first principles for the wavelength of tight and matter, which allowed a relativistic solution to the equations for wave particle duality (see Wave Particle Duality). This now indicates that these quintessential equations are compatible with relativity, quantum mechanics and quantum gravity.

Graviton Structure

From these observations, if the value for the gravitational constant is substituted into the equation (35) we may now estimate the probable geometric structure of the gravitation, which is the force particle mediating gravity by acting on quintessence. Thus the Gravitational constant has been previously derived from the vibration of quintessence by the equation:
G·(π/c)=9(πr_{q}²/m_{q}) (36)

This is in accurate agreement with the value for G(6.67×10⁻¹¹ N m² kg⁻²). This suggests that the most probable mathematical representation of the graviton (φ), the third force carrying particle is
φ=(π/c) (42)

Thus the gravitational constant (G) can be given by the mass and radius of quintessence and the structure of the graviton
G=9πr_{q}²/φm_{q} (43)

This shows the gravitational force to be related to the fundamental radius of quintessence space time, and the graviton.

Quantised General Relativity

The classical general relativistic formula, as given by Einstein is:
R_{μv}−1/2g_{μv}R=−κT_{μv}

Where R is effectively the curvature of space-time, R_{μv} denotes the contracted Riemann tensor of curvature and T_{μv} is the “energy tensor” of matter.)

If we substitute the energy tensor matrix of the electron (eq. 9)×time, for the energy tensor of matter T_{μv}; and the metric tensor of the space-time lattice×time for the contracted Riemann tensor we can arrive at the same solutions for general relativity.

Furthermore, in his published paper on General Relativity, Einstein. defined the constant κ as:
κ=8πG/c²

Therefore Einstein's equation should be written as

$${R}_{μν} - 1 / 2 {g}_{μν} R = \frac{8 π G}{{c}^{2}} \cdot {T}_{μν} \qquad ( 43 )$$

Einstein himself was apparently not happy about the right hand component of the equation. However, we find that this part of the equation can now be explained and quantised by substituting the gravitational constant, G=9πr_{q}²/φm_{q}, (eq. 42a),

Giving:

$${R}_{μν} - 1 / 2 {g}_{μν} R = - \frac{8 {π}^{2} 9 {r}_{q}^{2}}{φ {m}_{q} {c}^{2}} \cdot {T}_{μν} \qquad ( 44 )$$

By substituting m_{q}·c²=h, and further substituting h=h/2π, we arrive at a quantised solution to Einstein's equations. Where A_{q} is the surface area of quintessence (A_{q}=4πr_{q}²); φ is the graviton [φ=(π/c)] and h is Plancks constant. thus:

$${R}_{μν} - 1 / 2 {g}_{μν} R = - \frac{9 {A}_{q}}{φ ℏ} \cdot {T}_{μν} \qquad ( 45 )$$

The gravitational equation can now be further understood on a logical basis. The term A_{q}=(4πr_{q}²), where represents standard term for the surface area of a sphere of quintessence for the 9 space dimensions of the space time lattice, h is the energy content of quintessence×time and φ is the graviton, thus the right hand term now represents a true “metric energy tensor” of matter.

This leads directly to the standard solution to the field equations, for the general relativistic increase in radius r′ of an object, where A is the surface area of a sphere of a given mass M, such that
r=\sqrt{(A/4π)}−r=GM/3c² (34)

Furthermore, although equation 45, gives the same solutions as Einstein's equation, which is essentially correct, the difference is that the equation is now dependant upon Planck's constant (h), and moreover the radius of quintessence, which now defines a quantised solution to the equations.

Graviton Force Characteristics

Similar to the photon, the previously derived equation (42) for the graviton [φ=(π/c)] appears to also mathematically represent a helical ringlet of quintessence, but with a spin of 2. For the photon, taking the direction of motion as the x vector and its axis of spin also as the x vector, would account for the electromagnetic force and its attraction and repulsion characteristics. In the case of the gluon component (π/c^{1/2}), if the direction vector is x, then the axis of spin would be in the y vector, the same as quasi electrons, accounting for the particle binding characteristics of the gluon force. In the case of the graviton, if the direction of motion was in the x vector, the graviton spin axis would be in the z vector thus, as will be demonstrated, accounting for the gravitational force.

The spin axis of the graviton can also be derived using the known characteristics of the electron. If an electron is travelling in the x direction, then its spin axis is determined by the by the sign of the ⱼy vector (up or down). This view is in agreement with conventional theory, which indicates that the electron spin is similar to a rotating planet orbiting the sun, (the electron even appears to have orbital precession). As the electron passes through the space-time lattice, this spin would generate the formation of gravitons. This would occur as a result of the ejection of the excess quintessence passing through the electron. As the electron spins, the ejection of these gravitons would occur at a tangent to the electron's direction of motion. The ejection of the gravitons would occur, similarly to the ejection of energy of a pulsar or quasar, through the equivalent of the north and south poles of the electron. Thus, propelling the graviton in the direction of the electrons y vector. The ejection of the graviton would re-orientate and impart a specific angular momentum to the gravitons which would thus end up spinning on its own z axis. If for instance the graviton is released from an up spin electron the graviton will be rotating clockwise and its leading edge will displace quintessence downwards. In turn this will provide an upwards force.

This picture accounts for Fleming's left hand rule, is logical and provides an explanation for the magnetic force around a wire. According, to the left hand rule if the direction of the current is in the x vector, the magnetic field is in the z vector, and the force is upwards, in the y vector, in accordance with the above model. Therefore, this particular spin axis and the structure of the graviton results in its force characteristics. As the graviton is very small compared to the electron and both have different rather rapid spin axis it is difficult for these to bind and interact. Nevertheless, because the graviton has a spin of 2, and as it spin axis is perpendicular to its direction of motion, in the z vector, it readily displaces space-time quintessence to produce gravity. Thus because the graviton is able to displace space-time, it is capable of escaping a black hole. How else could the effects of gravity be felt beyond a black hole?

Quantum Gravity and Electromagnetism

With the above electron model of graviton production the nature of magnetism can be understood from first principles, Furthermore, the presence of a space-time lattice links relativity, and the forces of gravity with the electromagnetic and other forces of Nature. Indeed, evidence for these links may first date back to the 1820's, when Andre Ampere first defined the Amp. The force of attraction between two parallel wires 1 metre apart each carrying 1 Amp in a vacuum was defined as none other than the permeability of free space (2×10⁻⁷ N per metre of conductor). Thus conventionally the magnetic field strength around a long straight wire is given as:
B=μ₀I/2πr

Where I is the current and μ₀ is the permeability of free space (4π×10⁻⁷ N A⁻²)

The attraction between two wires both carrying negative charge is, however, counterintuitive as negative charges should repel. A conventional explanation overcomes this by invoking the presence of a magnetic field which is created by the current by the production of virtual photons. Thus we appear to have an explanation for the effects of magnetism which involves virtual photons, however, these photons are not observed. More accurately, according to conventional special relativity the magnetic field is none other than the electric field viewed relativistically.

A more satisfactory explanation, therefore, lies in the interaction between the electrons and the space time lattice. The moving electrons in the two wires interact with the lattice to produce gravitons; which are in phase when both streams of electrons are traveling in the same direction. The gravitonic waves interact constructively to disperse the space time lattice between the wires and induce an attractive force between the two wires, which produces in effect the permeability of free space. Thus this force results from the vibration of quintessence itself.

Conversely in two wires with current going in opposite directions the graviton waves are in anti-phase and would interact destructively between the wires. The gravitonic waves traveling radially outward from the wires would, however, disperse the lattice outside the two wires and produce apparent repulsion between the wires, which is exactly what is observed. These effects of electricity suggest that gravitons act as waves and that phase is important.

This effect is also seen with the north and south poles of ferromagnets. Nevertheless, with matter other than iron, cobalt or nickel, the graviton emission cannot be phased as the atoms are unable to align and magnets do not appear to exist with other materials.

In ordinary magnetic system the release of gravitons from the north pole would be exactly balanced by those released from the south pole of the magnet and hence there would be no net force on the magnet until an external magnet or electrical current were applied.

Overall the magnitude of the forces in electrical systems where electrical conduction occurs are well defined by the permeability and permittivity of free space μ₀, and ε₀. Where v is the constant velocity of the charge and ε is the electric field produced by the charge.
B=[μ₀ε₀]v·ε

These observations suggest that the forces of electricity which produce magnetism are indeed related to the permittivity and permeability of free space and that these quantities are exerted by an apparent vacuum. Thus the effects of magnetism could be explained by none other than the phased effects of gravitational waves on the space time lattice.

Electromagnetism is of further interest to quantum gravity, particularly if we combine the standard equations, B=μ₀I/2πr and B=[μ₀ε₀]v·ε, substituting for B we have:
2πr=I/ε₀vε (46)

Thus 2πr is proportional to the inverse of ε₀. Thus as space time is dispersed by gravitons the permittivity field will increase in the same way capacitance increases with separation of plates. Because of the inverse relationship between ε₀ and 2πr, as ε₀ increases the circumference of a circle and the apparent ratio of π is to r, will appear to diminish in accordance with general relativity. This not an actual diminution in the circumference of a circle but the effective reduction of the resistance to motion in a circular path in this field.

Incidentally, the above observations, also lead us directly to Schrödinger's formula for the average equilibrium distance (r) between an electron with charge (e) in orbit around a proton, which is conventionally given by:
r=n²4πh²ε₀/me²

Where ε₀ is again the permittivity of free space, m is the mass of the electron and n is an orbital integer, h is Planck's constant and e is the charge of the electron. Furthermore if e=[ε₀/3(4/3πc³)]^{1/2} (eq. 3); then the equation at n=1, for the electron orbital radius elegantly simplifies to:
r=4h²c³/m

Hence the orbital radius of the electron is related to spin of the electron (h) and its mass (m).

Quantum Gravity and the Charge of the Electron

The equation for the charge of the electron (eq. 1) contains the term so (permittivity of free space) which according to these observations should vary in a gravitational field.
e=[ε₀/3(4/3πc³)]^{1/2} (6a)

If we combine the standard equations, B=μ₀I/2πr and B=[μ₀ε₀]v·ε, substituting for B we have:
2πr=I/ε₀vε (46)

Thus 2πr is proportional to the inverse of ε₀. Thus as space time is dispersed by gravitons the permittivity field will increase in the same way capacitance increases with separation of plates. Because of the inverse relationship between ε₀ and 2πr, as ε₀ increases the circumference of a circle and the apparent ratio of π to r, will appear to diminish in accordance with general relativity.

Thus ε₀ rises when space-time is dispersed by the gravitons that produce the gravitational field, This occurs in a similar way to the process by which capacitance increases with separation of plates in a capacitor.

Nevertheless, as c is a constant and as c=[μ₀ε₀]^{-1/2}, then if ε₀ rises then μ₀ falls. This is entirely consistent as μ₀, which represents the force that quintessence exerts, would be reduced if the quintessence space time lattice is dispersed.

Furthermore, as μ₀=4π×10⁻⁷ N A⁻²; then as μ₀ falls, then the apparent ration π to r, also falls in a gravitational field. This is largely the same as stating, as does general relativity, that the apparent radius r′, rises in a gravitational field. So this view is consistent with general relativity.

Nevertheless, to derive an exact value for the charge of the electron we must account for gravity in the above equation. We will take the specific example of the Earth's gravitational field in order to obtain the exact value for the electron. If in accordance with standard general relativity, the apparent increase in radius r′ is:
r′=GM/3c² (34)

Then given that the mass of the Earth is 5.9745×10²⁴ kg; then
r′=1.47864×10⁻³ m
thus
2πr′=9.29057×10⁻³

Which is the incremental factor by which ε₀ must increase in Earth's gravitational field. So to correct ε₀ to account for gravity, ε₀ must be divided by the incremental factor, 2πr′. Similarly as effectively π decreases in a gravitational field, to correct π to account for gravity it must be multiplied by this incremental factor. So the equation for an electron in a zero gravitational field is:
e=[ε₀/3(4/3πc³)]^{1/2}÷(1+2πr′)=1.6022×10⁻¹⁹ C (6b)

This now gives the charge of the electron as measured in a zero gravitational field as 1.6022×10⁻¹⁹ C, which is the same as that measured on Earth. Notably these observations appear to suggest that the charge of the electron is the same irrespective of the gravitational field.

Virtually unlimited degrees of accuracy for the charge of the electron and for the fine structure constant (α), may be achieved by taking into account 2nd and nth order gravitometric effects. Thus if we take into account the effect of gravity upon the radius of the Earth it is also important to take into account an effect upon the instruments with which we measure quantities, this would be a second order gravitometric effect. Thus taking into account 2nd order effects (r″), we have a very small, but nevertheless relevant change, such that: r″=r′(1+2r′). Thus 2r″=9.3180486×10⁻³, and thus:
e=[ε₀/3(4/3πc³)]^{1/2}÷(1+2πr″)=1.6021765×10⁻¹⁹ C (6c)

This agrees exactly to the nearest 7 decimal places with the maximum accuracy of the experimental value for the charge of the electron. Furthermore by taking into account the nth order gravitometric effect, it is theoretically possible to predict accuracy for the charge of the electron to 3n decimal places. This mathematically accuracy confirms the structure of the electron from first principles and indeed the theoretical effects of gravity on the permittivity of free space (ε₀).

This returns us directly to the fine structure constant for the electron which is conventionally given by: α=e²/hc·4πε₀. If α=e²=ε₀/3(4/3πc³), accordingly the quintessential equation for α is structurally given by: 2π/α=m_{q}[3Θ]² (where Θ=4/3 πc³; see The Structure of the Electron and Matter), we must now take into account the effects of gravity, as above, thus:
2πα/m_{q}[3Θ]²÷(1_{—}2πr″)²=0.007297353

Where the gravitational term for the increase in radius r″ allows the mathematical derivation of α=0.007297353, and the above equation is in agreement with the conventional experimental value for α=0.007297353 to the nearest 9 decimal places.

Hence the term (1_{—}2πr″)² is in accordance with these observations for the effect of gravity on electromagnetic forces. To a maximum accuracy governed by current knowledge of the mass of the Earth and the Gravitational constant and thus the term for the gravitational increase in radius r′. These observations can also be used to accurately predict the magnetic moment of the electron

Thus the presence of the fine structure constant can now be further understood, by deriving the constant from first principles; specifically from the actual dimensional conformation for the charge of the electron: e=[ε₀/3(4/3πc³)]^{1/2} (eq. 6).

Overall the fine structure constant α (allowing for the term r′ which is the general relativistic increase in the radius of the Earth due to gravitation) is given by none other than the formula for the mass of quintessence and from the structure of the electron, which can now be derived from first principles to seven decimal places or more.

Quantum Gravity and the Electron Magnetic Moment

The theoretical origin and nature of magnetism remains obscure in current electromagnetic theory. An explanation suggests these magnetic effects are produced by photons, although no photons have ever been observed. To get round this difficulty it is postulated by physics that magnetism results from “virtual” photons. However, Maxwell's equation for electromagnetism states that the photon has no net magnetic effect.
δBₓ/δB_{y}/δy+δB_{z}/δz=0

Thus magnetism could not, by the above standard equation, be derived from a photon real or virtual.

In addition observational data suggests that black holes have powerful magnetic fields and as in theory photons are unable to escape from black holes (except for small quantities in the form of Hawking radiation), it would be difficult to explain these magnetic fields on the basis of photon emission.

Einstein postulated that magnetism was merely due to special relativity .sup.(ref 17). The postulate for the nature of magnetism in these current observations, states that the magnetic force results from relativity due to none other than the phased emission of gravitons (why postulate two invisible forces, magnetism and gravity, when one, the graviton, will do). This view as previously discussed (Quantum Gravity and Electromagnetism) is entirely compatible with standard relativity^{(ref 19)}. Thus with the graviton origin of magnetism, the equation for the magnetic moment of the electron should have an expression in terms of quintessence and in turn the gravitational force and in particular the graviton.

The standard term for the magnetic moment of the Bohr Magneton (SIB) is:
μB=eh/4πmₑ

In standard quantum mechanics the Bohr Magneton, μB, however, needs to be corrected to agree with experiment. The “correction factor” is termed “ε”; where ε=(α/2π)−0.328α²/π²=0.001159641. Thus theory reveals μₑ, the magnetic moment of the electron where:
μₑ=(eh/4πmₑ)[1+(α/2π)−0.328α²/π²]

The conventional derivation of the term ε above, is given from the fine structure constant, (α/2π) which is theoretically consistent. However, a rather arbitrary mathematical correction term; 0.328α²/π² needs to be used in this standard equation. This appears ad hoc and needless to say, more accurate measurements show, the electron magnetic moment to the Bohr magneton ratio, 1+ε=1.001159652, which suggests the correction factor is indeed incorrect. Nevertheless, this correction factor is essential for “renormalisation” and thus for quantum mechanics to work.

Quantum gravity readily explains the discrepancy between the theoretical Bohr Magneton (μB) and the actual measured magnetic moment of the electron (μₑ). In accordance with the above chapter (Quantum Gravity and the Charge of the Electron)

Thus the significant mathematical discrepancies can be removed by accounting for the effects of quantum gravity.

Thus taking the charge of the electron (e), using the equation for the Bohr magneton and the effects of quantum gravity such that gravitational change in radius is r″. The magnetic moment of the electron is given by:
μₑ=(eh/4πmₑ)(1+[α/2π÷(1+r″)])

This gives an electron magnetic moment to Bohr magneton ratio of 1.00115968. Thus the mathematical term for the magnetic moment of the electron is given, avoiding the arbitrary and dubious term 0.328α²/π² used in the standard equation, simply by accounting for quantum gravity.

It is now possible to unite the equations for gravity and magnetism by substituting the fundamental key equations of quantum gravity. Thus if: h=3m_{q}c² (eq. 1b) and mₑ=m_{q}n_{q} (eq. 2). Then we can express the magnetic moment of any particle with the charge of the electron, including the proton, in terms of the number of quintessences (n_{q}) in that particle.
μB=ec²/(4/3πn_{q}); (47)

Given that the postulated structure of the graviton is: (φ=π/c) (eq. 42), then substituting we have
μB=3ec/4φn_{q} (48)

Showing that the equations for the magnetic moment are compatible with the gravitational equations given earlier. Principally, the quintessential equations now allow the determination of the magnetic moment of any charged object from the equation for the graviton and directly from the number of quintessences it contains. In conventional physics the magnetic moment of the electron requires a correction factor, (1+(α/2πc)−0.328α²/π²), to derive the correct experimental value. These observations herein, indicate that the correction factor is more logically (1+r″), where r″ is the general relativistic increase in radius around a gravitational body. This suggests that magnetism is not only affected by gravity, but can, as shown as above, be derived using the quantum gravitational equations.

Quantum Gravity and Special Relativity

Ordinary matter passing through the lattice would produce gravitons which would interact with space-time as described by general relativity. The quantity of gravitons would be determined by the apparent mass and in turn these would apparently curve space time. The geometry of this “curvature” is elegantly described by general relativity using Riemann geometry, specifically using metric tensors. Intriguingly the metric tensor is not a single number, but at each point in space time it is required to consist of a collection of ten numbers, Consequently, ten dimensional space-time hypotheses, such as this or superstring theory, may automatically yield general relativity

General relativity is indeed very elegant, nevertheless there was a logical step yet to answer. That is, how do gravitons shape space time? This can now be readily answered by considering the interaction of a three dimensional space time lattice with gravitons themselves to produce the effects of gravity. The effects of gravity are as such to compel a body in motion towards the gravitational object and to a much smaller extent visa versa. This effect can only be produced If gravitons repel quintessence (the constituents of the 3D lattice). Indeed, it has been stated that in order to explain cosmic inflation and the “flatness” of the Universe that quintessence must shun (or be shunned by) matter.

In descriptive terms a body close to a large mass will have a tendency to move toward it because the three dimensional lattice would be less dense as it approached the surface of the large mass. Overall there would be less resistance to motion in the direction of the large mass, and the motion in this direction would be facilitated by the vibration of quintessence.

In general relativity the principle governing motion is the geodesic of least distance, this can be re-expressed using similar equations using least action. Furthermore, the concept of motion due to the vibrations of quintessence is more logically and experimentally compelling.

These observations can now be used to link general and special relativity. Thus as we approach the speed of light, the mass of an object travelling through the space-time lattice would approach infinity, directly because the number of quintessences passing through a body would increase with increasing velocity, hence the equation:
m′=m₀/(1−v²/c²)^{1/2} (50)
or
m′=m₀/(1−v^{2 [μ}₀ε₀])^{1/2} (50a)

In turn this would generate increasing gravitons and accordingly this would explain the observed effects of special relativity. Time itself is due to passage through the space-time lattice, and where the space-time lattice is dispersed by gravitons, time and length are reduced with increasing velocity and hence increasing space-time lattice dispersion, similar to the way in which gravity alters space-time

As a result:
t′=t(1−v²/c²)^{1/2}, l′=l(1−v²/c²)^{1/2}

Thus resulting in the effects of special relativity.

Quintessence and Black Holes

To address the relationship of the space-time lattice to gravity directly, it is important to discuss the concept of quintessence with regard to general relativistic equations. The standard general relativistic equation for the apparent increase in radius (r) due to the curvature of space time around a gravitational object, which has also been previously derived from first principles (eq. 36), is:
r′=GM/3c² (34)

This can also thus be written as:
3r′=GM[μ₀ε₀] (51)

This standard equation, is in keeping with the above observations. Specifically, as the mass increases, ε₀ increases, in turn the radius will appear to increase (relative to π).

The above observations now allow us to examine the effects with regard to the interior of black holes themselves. The event horizon would represent a critical density for quintessence, in which light could not escape. The Schwarzschild radius would now be given by:
Rₛ=2GM[μ₀ε₀]

The event horizon will occur at the point at which there is less resistance to circular motion than motion in a straight or partially curved line. Given that π is proportional to 1/ε₀. The event horizon should occur when the permittivity has increased by a factor of π.

Effectively because the permittivity of free space rises, π decreases. This is entirely in keeping with general relativity which predicts the effective change in the ratio of the radius to the circumference as given by the conventional equation, where r′, is again the apparent change in radius.
r=GM/3c²

Hence π will effectively decrease as we approach the event horizon of a black hole, When π decreases to 1, the circular circumference is equal to the diameter and moreover, inside this limit it is shorter for light to travel in a circle. Thus light cannot escape the event horizon.

This can give us great insights into the workings of space-time, for flat Euclidean space the standard equation is:
e^{iπ}=−1

In accordance with general relativity, the ratio of the radius to the circumference changes in a gravitational field, and effectively π=1, at the event horizon, thus the boundary condition for the shape of space-time at the event horizon now has the direct equation:
e^{f}

Within a black hole as the permittivity of space increases by a factor of 2π an object within it will complete two rotations rather than travel in a straight line. In effect exceeding the speed of light by 2π. Hence, the condition for space-time is represented by the equation:
e^{i/2}

Thus an increase in the permittivity of free space by a minimum factor of π, to produce a black hole is estimated to result from an increase in mass by a factor of approx. 10⁶ (the ratio of the mass of the earth and that of a putative black hole).

Continuing with the subject of a black hole, according to the model inside the black hole, the gravitons produced by the matter present would be in equilibrium with the density of the space-time lattice. Increasing the rate of rotation of the matter in the black hole for instance would thus increase the production of gravitons and its effective mass and increase the radius of the event horizon. A density gradient of the space-time lattice would continue to exist within the black hole. Progressively closer to the center of a black hole matter itself would be increasingly compressed and the spherical structure of the quasi electron would be predicted to collapse. This collapse would result in the formation of an exotic form of matter in the form of pure quintessence in a black hole.

This pure quintessence would produce the singularity at the centre of the black hole. The larger the black hole in terms of mass the more pure quintessence would exist at its core.

Quintessence and the Big Bang

Quintessence theory not only predicts the occurrence of the Big Bang, but allows a prediction for the value of the entire mass of the Universe, from first principles.

In accordance with quintessence theory the big bang resulted from the explosion of an immense black hole singularity, which was constituted from pure quintessence.

On the basis of quintessence, there will be a critical mass for Big Bang event; thus if entire space-time between quintessence is compacted so that no further quintessence can be accommodated, the addition of further quintessence would destabilize the immense black hole, resulting in the Big Bang.

It is possible to predict this critical mass, using the radius of quintessence as a benchmark. Given the nine spatial parameters present in the metric tensor, used in general relativity we find that the actual formula for the radius of quintessence; r_{q}², is mathematically in agreement with general relativistic theory when:
9r_{q}²=Gh/C³ (33)

This again supports the 9 dimensional view of space (so crucial in superstring theory). Moreover, the size of the vibrations of quintessence can thus be calculated as:
r_{q}=1.35×10⁻³⁵ m (33a)

The volume of each quintessence is thus:
4/3πr_{q}³=1.0306×10⁻¹⁰⁴ m³ (33b)

So to be accommodated within unit volume of space time, with no intervening apparent space time, (given that each of 9 overlapping quintessences are required) would require approx.
9×10¹⁰⁴ quintessences

As the mass of quintessence is m_{q}=h/c²=7.373×10⁻⁵¹ kg sec (eq. 1). Then the mass of the Universe, to two decimal places, is:
1.18×10⁵³ kg (33c)

This is in close agreement with a recent estimate of the mass of the Universe from COBE and other satellite data, which estimates the mass to be 100 trillion trillion trillion trillion tonnes (10⁵³ kg)

Moreover, the early formation of the galaxies can be readily explained, it is likely that in such a big bang some very small black holes might have prevailed and that these formed the seeds of the galaxies we see today.

The event horizon, calculated from the Schwartzschild radius, of such an immense black hole is about 10²⁶ m, which would have allowed Guth's inflationary component to the early expansion of the Universe.

In addition, inflation may result directly from the observation that once electrons have formed from the primordial soup of quintessence, they emit gravitons which in turn repel space time, which might also result in another cosmic inflationary cycle.

Most importantly quintessence theory explains the Big Bang from first principles and is capable of accurately predicting the mass of the Universe.

The Nature of Energy

These observations allow a fundamental understanding of energy. The quantum physical, minimum component of energy is Planck's constant; h. To define the minimal component of mass, using the standard energy equivalence formula; E=mc², such a minimal mass (m_{q}) would be required to have the value equivalent to; m_{q}=h/c² (1). The total mass of a system (m) would then be; m=m_{q}n_{q}, where (n_{q}) is the number of these minimal units. Thence, the total energy of a system can be derived from the minimal energy; h, multiplied by the number of these energy units (n_{q}). Thus as, E=mc², then also E=m_{q}n_{q}c² and substituting m_{q}=h/c², the energy equivalence formula has the more logical formulation;
E=hn_{q} (1a)

Thus the energy of a system is equivalent to the minimal energy unit; h, multiplied by the number of those minimal energy units (n_{q})

This leads directly to a deeper understanding of wave particle duality and the wave nature of matter.

This is encapsulated by the quintessential energy formulae

As conventionally β·E/c=p, then
λ=h/p=hc/βE (2)
and
E=hn_{q} (1a)
then
λ=c/βn_{q} (2b)

Importantly, as indicated by equation (2b), energy having no quintessence; would have a wavelength of infinity. Specifically pure energy containing no quintessences, would have a lambda of infinity. According to quantum mechanics an infinite wavelength would result in the probability of that energy being anywhere. As energy itself has no electrical charge it would not be impeded by the permittivity and permeability of the three dimensional space-time lattice. Moreover, energy would not be detectable in three dimensional space-time, unless it interacted with matter, as in the EPR experiments. Indeed, energy is not observed when not bound to any form of mass or particle.

Thus equation 2b, takes us to our original assertion regarding the existence of pure energy.

Energy is not Bound by the Space-Time Lattice

Thus, as the EPR experiments suggest the existence of energy separate from matter and thus separate from the three dimensional space-time lattice, it is interesting to find that experiment suggests the existence of free energy in a continuum separate from space time and matter to produce the effects of quantum teleportation.

This is not, however, teleportation across an additional dimension, this is a term to describe in partially familiar terms the dissociation of energy from the three dimensional space-time lattice. As time is inextricably linked to each dimension of space, the effects of energy would be inextricably linked to the events, such as the creation of virtual particles, we see interacting within space-time. It is unlikely that observers have any direct day to day experience to explain quantum events. Nevertheless, quintessence theory may have given us a window into the hitherto hidden workings of the Universe. Thereby, the mystery of the uniformity of the Universe, across distances which the speed of light could not apparently traverse, is readily explained by the fact that the free energy contained in the Universe is not bound by the space-time lattice.

In the case of light, due to the exceedingly small masses involved, there would be relatively easy exchange of matter with free energy within a photon. This would make the photon the ideal experimental tool to look for energy which is not bound by matter and in turn energy which is not bound in space-time. Indeed, very recently Furusawa et al. have reported to have observed the transference of energy as photons from A to B, without those photons traversing space-time. This finding which has been supported using other experimental techniques, is very important as it suggests the existence of such free energy.

Overall, quintessence theory gives an a priori explanation for the concept of mass, the elementary particles, the forces of nature and quantum effects. It can equally be used logically to explain the inner physics of a black hole, the missing mass in the Galaxy, the expansion of the Universe, Guth's inflationary theory and predicts the Big Bang, from first principles.

Part IV: Applied Theory with the Intent to Create Closed Timelike Curves

Electron Bombardment of the Photosphere to Induce Gravitational Shift

Leveraging the above relationship between mass and quintessence we derive that if an electromagnetic radiation with velocity v strikes the event horizon singularity of rest inertial mass mi, and U is the electromagnetic energy absorbed by the singularity, then, according to Maxwell's prediction, a momentum q=U/v is transferred to it. Mass shift d·m_{b}, dependent on the external electromagnetic energy, equals the inertial mass shift dependent on the increment of energy in the particle. Since in this case the inertial mass shift does not depend on velocity V, i.e., it is related only to the momentum q absorbed, it can be obtained by making p=0 in variation ΔH=H′−H=c[q²+(mᵢc)²]^{1/2}−(mᵢc)² from the particles inertial Hamiltonian. Consequently, the expression of dₘ_{ₚ}, is written as:

$${d}_{{m}_{p}} = Δ H / {c}^{2} = {m}_{i} \sqrt{1 + U / {m}_{i} {c}^{2} [ {ɛ}_{r} {u}_{r / 2} {\{ \sqrt{1 + d / w {ɛ}^{2} + 1} \}}^{2} = 1}$$

Comparing now the expression of mᵢ and m_{g} we have m_{g}=mᵢ−2dm_{b}. By replacing m_{b} in this equation, given by equation above, we obtain the expression of the correlation between gravitational mass and inertial mass, i.e.,

$${m}_{g} = {m}_{t} - 2 \sqrt{1 + U / {m}_{t} {c}^{2} [ \sqrt{{ɛ}_{r} {u}_{r / 2} {\{ {[ d / we ]}^{2} + 1 \}}^{2} - 1}} \cdot {m}_{t}$$

We see that only in the absence of electromagnetic radiation on the event horizon (U=0) is the gravitational mass equivalent to the inertial mass. Note that the electromagnetic characteristics, e, m and s do not refer to the singularity itself, but to the outside medium around the singularity (photosphere) in which the incident radiation is propagating.

Stable CTC Solution From Modified M-Theory

Our innovation is a method of creating an event where a dual membrane or dual boundary condition exists. We do this using generalization from a Misner space which has been modified if one analytically continues the maximal extended Misner Metric so that ds²=−du²+dw²+(dx²)²+(dx³)² to the Euclidean section so that u=iota zeta we obtain a Misner instanton on the section where w and zeta are both real. The Euclidean time, t, and the closed spacelike coordinate are both periodic, the later having a period of 2Πt². Going back to the Lorentzian sector we find that the period of the closed coordinate becomes linearly dependent on the physical time. Using automorphic fields in the Hadamard function one can obtain a quantized condition for time. This gives us a figure on the order of the Plank time. This confines such a stable wormhole condition to the general area of the Plank scale in its modified form which is that area defined by the Membrane itself. As such, these Plank scale wormholes are the true source of the true virtual aspects of the vacuum and quintessence. The effects of the dual singularity system can be viewed as an overlap zone of two distinct space-times which have boundary conditions on both sides. As an object accelerates towards C it is this same boundary or horizon that object encounters when the Time defined horizon solution for the universe is imposed. At this point drawing upon Van Den Broeck's alterations for this space-time geometry to create a single closed Friedman-Robertson-Walker spacetime the space-time geometry can be represented by this equation ds²=dct²−B²[(dx−βfdct)²]+dy²+dz² B can be any function that is large near the displacement device. We then consider this transformation as extended to four dimensional space-time with arbitrarily time dependent acceleration. We also present the device frame energy density T00 from a four dimensional calculation and note that the 4d classical calculation is everywhere finite.

Consider an Alcubierre interval given according to a remote frame's cylindrical coordinates by:
ds²=(1−β²f²)dct²+2bfdctdz−dz²−dr²−r²df²
where f is a function that is 1 at the location of the device and zero far from it.

Starting out with the first transformation z′=z−òct beta dct. Where b is first expressed here as a function of time ct. With some algebra for simplification this results in
ds²=[1−β²(1−f)²]dct²−2b(1−f)dctdz′−dz²−dr²−r²df²
Let g=1−f and this becomes
ds²=[1−β²g²]dct²−2bgdctdz′−dz′²−dr²−r²df²

Notice that this returned the original intervals form with a reversal on the sign of b and a reversal of the boundary conditions for g. Now we notice that at r=0, this interval becomes the interval for special relativity transformed to cylindrical coordinates. Thus, we have found a transformation to a frame based local to the device. One can also verify that in these coordinates the relevant affine connections vanish at r=0. a further proposed modification to this field we will reintroduce a time dilation term into the devices frame's interval. Only we will use different boundary conditions for it. We will keep A=1 both at the location of the device, and far from it, but allow it to become large in the warped region. This is achieved by the simplest means possible in the proposed field generation method. Since rotating kerr singularity under bombardment would produce an equal negative energy region. With the effect focused outward away from the device slightly by the relative alignment of the kerr singularity the actual inward going portion of such fields would overlap and cancel their effect out in the region of the device. This yields a space normal time region, which is again restored at the fringes of the outward going field. From the standpoint of a geometric picture of space-time around the device and extending outwards one has actually created a dual event horizon situation as far as time goes. The inner one is the shell of the canceled out field inside of which normal time flow is restored. The outer one is formed at the boundary where normal time resumes and within which we have a negative energy field.

### SUMMARY OF THE INVENTION

The present invention is A method for the generation of a pseudo 2+1 dimensional anti-de Sitter space (DeDeo & Gott 2002) using two Kerr type positively charged rotating dilation singularities where one singularity is maintained as a axis of rotation or “reference” singularity, and the other “target” singularity is subjected to a differential electron flow so as to simultaneously pass above the photosphere of said singularity in its direction of rotation—prograde orbit—and contrary to its direction of rotation—retrograde orbit—to release a directed flow of gravitons in a sinusoidal oscillation simulating a rotational effect of the “target” singularity around the axis of rotation provided by the “reference” singularity, resulting in the creation of timelike curves in a compact time-oriented manifold permitting topology change from one spacelike boundary to the other in accordance with Geroch's theorem (Geroch 1967) which results in a method for the formation of G odel-type geodesically complete spacetime envelopes complete with closed timelike curves.

### BRIEF DESCRIPTION OF THE DRAWINGS

FIG. 1 is a schematic representation of the mechanism employed to house the components necessary to generate a 2+1 dimensional anti-de Sitter space, resulting in the creation of timelike curves in a compact time-oriented manifold

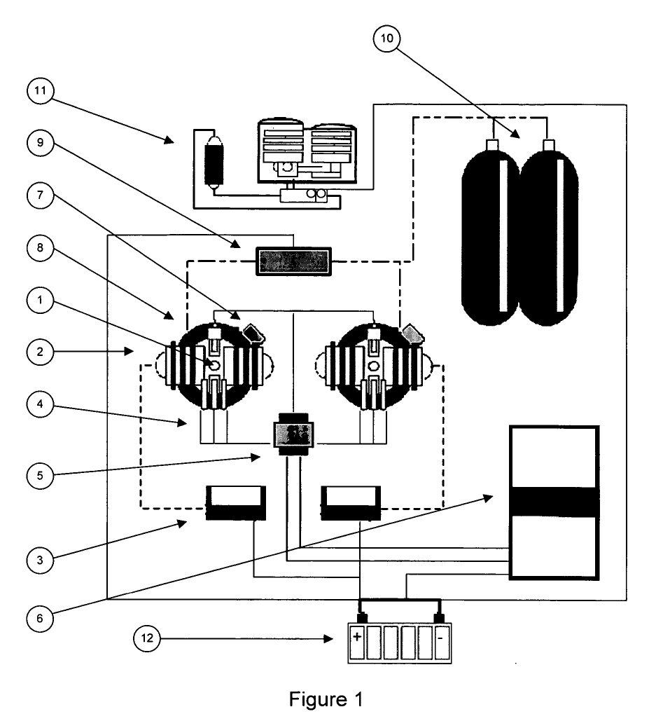

FIG. 2 is a schematic representation of the G odel-type geodesically complete spacetime envelope created by the mechanism complete with closed timelike curves

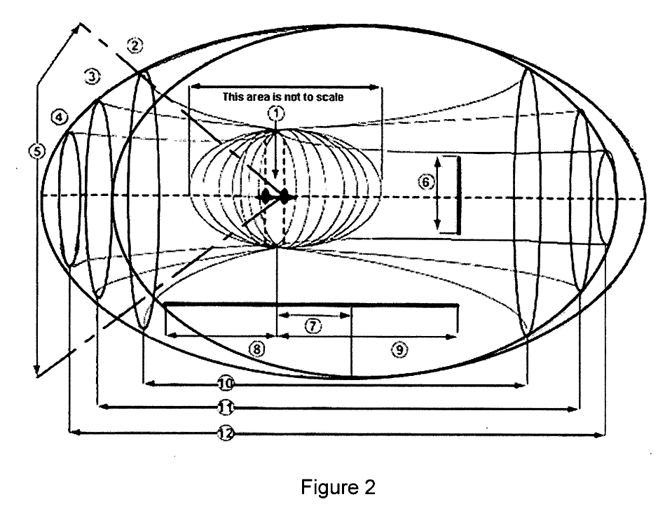

### DETAILED DESCRIPTION OF THE INVENTION

Principles of Gravity Distortion Time Displacement Systems

The theoretical understanding of quantum gravity allows the design of time displacement systems from first principles. It is unlikely that gravitons or Kerr singularities can be controlled in a precise way using current technology. Nevertheless, an understanding of three dimensional space-time and matter, does allow the design of elementary displacement systems. That is, systems whose displacement rely on direct warping space-time as opposed to the ejection of material to provide thrust resulting in time dilatational effects.

The background for these systems are already partially understood and quintessence theory allows their further development. For this invention, the formation of black holes in the laboratory represents a crucial step in understanding the mechanisms that underlay gravitational physics and in turn the warping of space-time. The existence of black holes permits the localized application of the Axial torsion Spin-Rotation Coupling Effect (Zhang & Beesham 2002) resulting in a Rotating Frame with Relativistic Factor (Zhang 2003) which can be used in the creation of a Alcubierre space time bubble under the Van Den Broeck modification of the Alcubierre geometry (Van Den Broeck 1999) resulting in a method for the generation of a pseudo 2+1 dimensional anti-de Sitter space (DeDeo & Gott 2002) using two Kerr type positively charged rotating dilation singularities where one singularity is maintained as a axis of rotation or “reference” singularity, and the other “target” singularity is subjected to a differential electron flow so as to simultaneously pass above the photosphere of said singularity in its direction of rotation and contrary to its direction of rotation to release a directed flow of gravitons in a sinusoidal oscillation simulating a rotational effect of the “target” singularity around the axis of rotation provided by the “reference” singularity. In this instance the space-time lattice would be repelled by gravitons in such a way as to disperse space-time quintessence in a circular fashion around each of the singularities, producing multiple event horizons around the simulated axis of rotation provided by the reference singularity.

The release of gravitons from the target singularity is controlled by differentially governing the electron flow across the photosphere with the use of powerful electric currents. In turn the differential direction of flow across the photosphere of gravitons would determine the direction of motion through the space time lattice and the resulting time displacement from one spacelike boundary to the other in accordance with Geroch's theorem (Geroch 1967) when implementing this approach it is important to remember that the black hole is not excited by the smashing of the clump as it “hits” the horizon. The hole is rather excited when the metric perturbation associated with the clump is “felt” by the background metric. The excitation event therefore constitutes a smooth process whereby in-fall of a clump from .rmb and through r+ serves as a source in the Teukolsky (1973) equation for small perturbations to the Kerr geometry (with appropriate boundary conditions at r+ and r∞). This is an important distinction with a great deal of relevance to the practical engineering of the displacement unit since we need to gauge the “driving” of QNR modes in terms of an e_ective coupling from clump in-fall.

What results is a method for resonant driving of the quasi-normal ringing (QNR) wave modes of the Kerr geometry of the target singularity. The micro black hole hyper-accreting at rates ÿ M. 1 M□sec. 1 from a neutrino cooled disk is pushed through to oscillate near resonance of its (l,m=2, 2) quadrupole QNR frequency due to the in-fall of compact mass over-densities from the cusp in e_ective potential on a dynamical time scale. This mode is induced via induced magneto-rotationally induced fluid dynamics in the ultra-relativistic region of the flow bounded from below by the marginally bound orbit radius: rmb If the QNR modes are fed resonantly for a few seconds of hyper-accretion, the enhanced amplitude of the oscillations yields a very high rate of energy deposition into gravitational waves. Indeed, the integrated energy deposition is large enough to “evaporate” the equivalent of a factor of a few times the total rest mass-energy of a single clump into gravitational waves, which in turn interact with the reference singularity

Application of the method described in the previous section results in translation outside of the cosmological horizon, where F(R)<0. The topology of the resulting geodesic, for large constant R, is mathematically equivalent to a Euclidean cylinder of the condition R×Sn where T is the coordinate along the cylinder. I± are located outside the future/past cosmological horizons, where R is timelike and T is spacelike. In the case of a rotating Kerr black hole, there are two circular photon orbits that can exist in the equatorial plane and be exploited to create a tipler sinusoid. One is a prograde orbit moving in the same direction as the black hole's rotation, while the other is a retrograde orbit moving against the black hole's rotation. Their radii are respectively given by
r1=2M(1+Cos(2/3 arccos(−|α|/M)))
r2=2M(1+Cos(2/3 arccos(|α|/M)))
where a is the angular momentum per unit mass of the black hole. The orbits fall in the range M greater or equal to r1 greater or equal to 3M greater or equal to r2 greater or equal to 4M The fact that a prograde photon or in or case cooper pair with Bose characteristics orbits the black hole at a smaller radius than a retrograde one can be attributed to the well-known Lense-Thirring effect, i.e., the dragging of inertial frames due to the black hole's rotation which we control and influence via electromagnetic induced load coupling with the open magnetic field lines threading the BH horizon. This dragging would cause charged cooper pairs to revolve around the black hole relative to a static observer at infinity. Thus, to such an observer, a prograde cooper pair would have to orbit at a smaller radius to compensate for the ‘extra’ angular momentum acquired, while a retrograde one would have to orbit at a larger radius to compensate for the ‘lost’ angular momentum. Indeed, in the limit of zero rotation, these two orbits coincide at r D 3M, giving the single circular orbit of the Schwarzschild black hole. Now, recall that orbits around the Schwarzschild black hole are necessarily confined to a plane passing through its center, because of the spherical symmetry of the space-time. However, the Kerr black hole space-time has only an axial symmetry (in addition to being stationary), and this raises the possibility of non-planar orbits. One could, for example, contemplate the existence of spherical Boseon orbits—orbits with constant coordinate radii that are not necessarily confined to the equatorial plane—around the Kerr black hole. Such orbits would be a nontrivial generalization of the two circular photon orbits that lie in the equatorial plane. At first it may seem a little surprising that such spherical orbits could even exist, but there is an interesting reason as to why they are possible. Note that an object in a spherical orbit would, in addition to moving around the black hole in the azimuthal direction, be undergoing some periodic motion in the latitudinal direction. This is only possible if there is a conserved quantity associated with motion in this direction, just as angular momentum is necessarily conserved by its rotational motion in the azimuthal direction. (This result can be seen, for example, using action-angle variable) Now, because the Kerr space-time has only axial symmetry, geodesics in it should have only two constants of motion, namely energy and angular momentum. However, Carter discovered the remarkable fact that geodesics in the Kerr space-time possess a third constant of motion. It turns out that Carter's new constant governs the motion of geodesics in the latitudinal direction, although it is not related to any obvious space-time symmetry. Thus, spherical timelike orbits, which assume eigenlike properties around the Kerr black hole, are possible and when coupled with charged Bosons may be exploited to manipulate the relative event horizons of the “target” singularity. The location and the temperature of the modified event horizon depend on the time, charge and angle of incidence of the cooper pairs. The Fermionic spectrum of Dirac particles displays a spin-rotation coupling effect due to the interaction between the particles with spin-1=2 and the black holes with rotation. The effects arise from the interaction between the spin of Dirac particles and the rotation of the evaporating black holes. The feature of this spin-rotation coupling effect is its dependence on different helicity states of coupled particles with spin-½ and its irrelevance to the mass of particles.

In order to design a mechanism for time displacement exploiting the Carter asymettry cited above we utilize two positively charged top spin rotating kerr type black holes aligned on demand to create a simulated rotational effect around a central axis provided by the “reference” singularity. In the case of the Kerr blackhole (singularity), this is accomplished by an inverse Blandford-Znajek (BZ) process utilizing the magnetic flux of open field lines connecting the horizon and an induced remote load. (Ding-Xiong Wang, Kan Xiao & Wei-Hua Lei, 2001) permitting the microscopic blackhole (singularity) to be rotated along its horizontal axis in at relativistic centrifugational speeds. A differential current is then applied in such a way as to pass through the entire photosphere in the desired direction. As a result the gravity field can be manipulated by three factors that affect it in distinct ways. Adding electric charge to the singularities increases the diameter of the inner event horizons. Adding mass to the singularities increases the area of gravitational influence around the singularities. Rotating and positioning the polar axis of the singularities affects and alters the resulting gravity sinusoid

In order to create a sinusoid capable of inducing a topology change from one spacelike boundary to the other in accordance with Geroch's theorem The electric charge in the upper half of the photosphere would be maximised. The electrons will have a vector in the left to right direction as the singularity spins clockwise. If a maximised current is applied to the singularity in the same direction this will result in a increase in the velocity of the electrons relative to the centre of gravity of the singularity, due to the flow of current. In turn, according special relativity and to the space-time lattice model, this wilt result in an increase in the relativistic mass if the electrons and in turn by general relativity an increase in the release of gravitons.

Conversely in the lower half of the singularity the electrons will have a vector of motion in the right to left direction due to the spin of the singularity. This will be relativistically slowed by the differential current applied in the same direction as the current above, and hence in the opposite direction to the direction of rotation. The charge can be separately applied and adjusted to ensure that the electrons are relativistically stationary relative to the centre of gravity. In turn this will minimize the relativistic mass and result in a decrease in the release of gravitons for the lower half of the singularity.

The overall result will be a greater release of gravitons in one direction and a lesser release of gravitons in the converse direction. The effect will be enhanced by the use of a multi-phasic current simultaneously applied. This will result in the release of multi-phasic gravitons which will disperse space time in the singularity with increase in density in the converse this effect can also be produced and supplemented with the use radio frequency pulses, The radio frequency pulses must be designed to produce a change in the spin of the particle to enhance the release of gravitons in the desired direction

With the use of large currents the drift velocity of the electrons across the photosphere could be greatly increased. Within this region the electrical resistance is virtually eliminated. Thereby allowing large currents to be induced with minimum total power output.

The result is the production of cooper paired electrons of high speed and hence high relativistic mass in the desired half of the singularity, whilst producing low speed and thus low mass paired electrons at the converse of the singularity, in accordance with special relativity. The imbalance in the rotating singularity will be continuously present creating a dynamic warping of space-time. In effect, the differential current flow, will produce differential graviton production and in turn, by general relativity, the warping of space-time

As the cooper pairs cross the photosphere, accretion of the Bose particles results. Near-hole accretion across the target singularity is then motivated by magneto-rotationally induced, ultra-relativistic disk dynamics in the region of the flow bounded from below by the marginally bound geodesic radius rmb. As the particles impelled have high spin values, a largely coherent magnetic field in this region has the dynamical implication of compact mass segregation at the displacement nodes of the non-axisymmetric, MRI modes. This results in prolific gravitational wave emission coincident with the gamma-ray stage. The gravitational wave emissions are then manipulated to influence the reference singularity to produce a variable gravitational sinusoid which is then used to mathematically approximate the gravametric distortion, inducing a topology change from one spacelike boundary to the other in accordance with Geroch's theorem.

### BIBLIOGRAPHY

Mesoscopic behaviour of the neutral Fermi gas ³He confined in quantum wires. S. L. Phillipson, A. M. Genault, S. N Fisher, G. R. Pickett, P. J. Y Thibault. Nature, 395: 578-580.
Direct Observation of d-orbital Holes and Cu—Cu Bonding in Cu₂. J. M. Zuo et al. Nature 401: 49-52.
The Foundation of the General Theory of Relativity, A Einstein. Translated from “Die Grundlage der Allgemeinen Relativittstheorie”. Annalen der Physik, 49, 1916. Published in, Einstein, The Principle of Relativity, Dover publications, 1952.
Sidelights on Relativity. Ether and the Theory of Relativity Albert Einstein. Dover Publications 1983.
Inflation is dead long live inflation. George Musser. Scientific American, July 1998, p 9.
The flip side of the Universe. George Musser. Scientific American, September 1998, p 13.
The Fifth Element, Marcus Chown. New Scientist, Apr. 3, 1999, pp 29-32
The Quantum Universe. Tony Hey and Patrick Walters. Cambridge University Press 1987. (Solving the Shrodinger equation pp. 165-167).
Complex Numbers, Mathematics for Engineers. W. Bolton; Longman Scientific & Technical; Chap. Introducing Complex Numbers, p 1-11.
Unconditional Quantum Teleportation. A. Furusawa, I. Sorensen, S. L. Braunstein, C. A. Fuchs, H. J Kimble, E. S. Polzik. Science, Oct. 23, 1998. Vol. 282: 706-709.
Complete quantum teleportation using nuclear magnetic resonance. M. A. Neilsen, E. Knill, R. Laflamme. Nature, Nov. 5, 1998. Vol. 396: 52-55.
Experimental quantum teleportation. D. Bouwmeester et al. Nature, 390: 575-579 (1997).
Experimental realization of teleporting an unknown pure quantum state via dual classical and Einstein-Podolski-Rosen channels. D. Boschi, S. Branca, F. De Martini, L. Hardy, S. Popescu. Phys. Rev. Lett. 80: 1121-1125 (1998).
W. Tittel, J. Brendel, H. Zhuniden, N. Gisin, Phys. Rev. Lett. 81: 3563-3566. (1998) into the Vortex. Charles Seife. New Scientist, Oct. 24, 1998. p 7.
Direct observation of a fractional charge. R de Picciotto, M Reznikov, M. Heibium, V Umansky, G. Bunin, D. Mahalu. Nature, 389: 162-164.
Tables of Physical and Chemical Constants. Kay & Laby. Longman Scientific & Technical.
Physics in Focus. Michael Brimicombe. Section, Wave Mechanics; p 521. Nelson Special Relativity. A. P. French. Nelson. Chapter 8, Special Relativity and Electricity, pp 256.
Universe In Balance. Jeff Peterson. New Scientist, 168: p 27
The Accelerating Universe. Mario Livio. John Wiley and Sons, Inc. (2000)
Escape from Earth, Charles Seife, New Scientist, Feb. 6, 1999. p 6.
The Discovery of the Top Quark. Tony Liss and Paul Tipton. Scientific American; September 1997, pp. 26-41.
The Mystery of the Nucleon Spin. Klaus Rith and Andreas Schaifer. Scientific American: July 1999, pp 42-47.
And you're glue. Frank Wilczek. Nature; 400, pp 21-23.
The warp drive: hyper-fast travel within general relativity Miguel Alcubierre —Classical and Quantum Gravity, vol. 11, L73-L77, (1994)
Photon propagation in a stationary warp drive space-time: Claes R. Cramer (1995)
Some thoughts on the Implications of Faster-Than-Light Interstellar Space Travel: I. A. Crawford, Quarterly Journal of the Royal Astronomical Society, vol. 36, 205-218, (1995)
Physical and Cosmological Implications of a Possible Class of Particles Able to Travel Faster than Light: Luis Gonzalez-Mestres: Contribution to the 28th International Conference on High Energy Physics, Warsaw (Poland), (1996)
Warp drive and causality: Allen E. Everett, Physical Review D, vol. 53, 7365-7368, (1996)
A Superluminal Subway: The Krasnikov Tube, Allen E. Everett & Thomas A. Roman, Physical Review D, vol. 56, 2100-2108, (1997)
Quantum effects in the Alcubierre warp drive spacetime, William A. Hiscock, Classical and Quantum Gravity, vol. 14, L183-L188 (1997)
The unphysical nature of “Warp Drive”, Michael J. Pfenning & L. H. Ford; Classical and Quantum Gravity, vol. 14, 1743-1751, (1997)
On the Possibility of a Propulsion Drive Creation Through a Local Manipulation of Spacetime Geometry; Vesselin Petkov; Presented at the 34th
AIAA/ASME/SAE/ASEE Joint Propulsion Conference, (1998)
‘Operational’ energy conditions, Adam D. Helfer; Classical and Quantum Gravity, vol. 15, 1169-1183, (1998)
No warp drive; D. H. Coule; Classical and Quantum Gravity, vol. 15, 2523-2527, (1998)
Quantum Inequality Restrictions on Negative Energy Densities in Curved Spacetimes, Michael John Pfenning; Doctoral Dissertation, (1998)
Hyperfast Interstellar Travel in General Relativity; S. V. Krasnikov; Physical Review D, vol. 57, 4760, (1998)
Superluminal travel requires negative energies; Ken D. Olum; Physical Review Letters, vol. 81, 3567-3570, (1998)
Hyper-fast travel without negative energy, Eric Baird; (1999)
Warp drives, wavefronts and superluminality, Eric Baird; (1999)
A traversable wormhole, S. Krasnikov; (1999)
Speed Limits in General Relativity; Robert J. Low; Classical and Quantum Gravity, vol. 16, 543-549, (1999)
Null geodesics in the Alcubierre warp drive spacetime: the view from the bridge; Chad Clark, William A. Hiscock & Shane L. Larson; Classical and Quantum Gravity, vol. 16, 3965-3972, (1999)
A ‘warp drive’ with more reasonable total energy; Chris Van Den Broeck; Classical and Quantum Gravity, vol. 16, 3973-3979, (1999)
On the warp drive space-time, Pedro F. Gonzalez-Diaz; Physical Review D, vol. 62, 44005-44012, (2000)
On the (im)possibility of warp bubbles; Chris Van Den Broeck; Summary of talk delivered at STAIF-2000, (2000)
Reduced Total Energy Requirements for a Modified Alcubierre Warp Drive Spacetime; F. Loup, D. Waite & E. Halerewicz Jr. (2001)
Warp Drive With Zero Expansion, Jose Natario; Classical and Quantum Gravity, vol. 19, 1157-1166, (2002)
A Causally Connected Superluminal Warp Drive Spacetime; F. Loup, R. Held, D. Waite, E. Halerewicz, Jr., M. Stabno, M. Kuntzman & R. Sims, (2002)
Weak Energy Condition Violation and Superluminal Travel; Francisco Lobo & Paulo Crawford (2002)
On the Problems of Hazardous Matter and Radiation at Faster than Light Speeds in the Warp Drive Space-Time; C. B. Hart, R. Held, P. K. Hoiland, S. Jenks, F. Loup, D. Martins, J. Nyman, J. P. Pertierra, P. A. Santos, M. A. Shore, R. Sims, M. Stabno & T. O. M. Teage, (2002)
2+1 gravity, chaos and time machines; Bengtsson I and Brannlund J, J. Math. Phys. 42 (2001) 3565
Time Travel in Einstein's Universe: the Physical Possibilities of Travel through Time, Gott J R; Houghton Mifflin Company, Boston, 2001
Gravitational memory of natural wormholes, Anchordoqui L A Trobo M L Vucetich H Zyserman F Mod Phys Lett A 15(6): 429-438, 2000
A traversable singularity-free wormhole. The gravitational memory phenomenon Gott time machines, BTZ black hole formation, and Choptuik scaling, Birmingham D, Sen S; Phys Rev Left 84 (2000) 1074-1077
   [It is shown that the Gott time machine provides a mechanism for black hole formation]
Negative energy, wormholes and warp drive, Ford L H, Roman, T A; Sci Am: 46-53, 2000 Jan (reply: 2000 May p. 12)
Warp drive space-time; Gonzalez-Diaz P F; Phys Rev D62: 044005 (2000)
Misner-brane cosmology, Gonzalez-Diaz P F; Phys Lett B486: 158-164 (2000)
Kinks, energy conditions and closed timelike curves; Gonzalez-Diaz P F; Int J Mod Phys D 9(5): 531-541, 2000. (gr-qc/0007065)
Will we travel back (or forward) in time? Gott J R; Time, Apr. 10, 2000 pp 68-70
Charged universes of the Godel type with closed timelike curves; Klepac P and Horsky J, Class Quant Grav 17(13): 2547-2555, 2000
The Ori-Soen time machine, Olum K D; Phys Rev D61 (2000) 124022
How much energy do closed timelike curves in 2+1 spacetimes need?, Tiglio M H, Phys Rev D61 (2000) 08 1503
Energy conditions and their cosmological consequences, Visser M and Barcelo C gr-qc/0001099
Cylindrically symmetric spinning Brans-Dicke spacetimes with closed timelike curves Anchordoqui L A, Perez Bergliaffa S E, Trobo M L, Birman G S; Mod Phys Lett A14 (1999): 1105-1112
From spinning to non-spinning cosmic string spacetime; De Lorenci V A De Paola R DM Svaiter N F, Class Quant Grav 16(10): 3047-3055, 1999
Bounds on negative energy densities in static space-times, Fewster C J, Teo E; Phys Rev D 5910(10): 4016, 1999
Decohering a charged scalar field in a time-machine wormhole background, Flagga M SN; Int J Theor Phys 38(8): 2121-2161, 1999
Rotating black holes in unified theories; Gibbons G W. Progress of Theoretical Physics Supplement. (136): 18-28, 1999
Supersymmetric rotating black holes and causality violation; Gibbons G W and Herdeiro C AR, Class Quant Grav 16 (11) 3619-3652, 1999
Perdurance of multiply connected de Sitter space; Gonzalez-Diaz P F, Phys Rev D 59, 1999, 123513
Nonorientable spacetime tunneling; Gonzalez-Diaz P F, Garay L J, Phys Rev D 59 (1999) 064026
Can the universe create itself?; Gott J R, and Li X L, Phys Rev D 58, 1998, 023501. Also: astro-ph/9712344
Supersymmetric rotating black holes and causality violation; Holst S, Matschull H-J Class Quant Grav 16, 1999, 3095
Godel-type universes in string-inspired charged gravity; Kanti P, Vayonakis C E, Phys Rev D 60, 1999, 103519
Quantum field theory and time machines; Krasnikov S., Phys Rev D 59: 4010, 1999 Jan 14 Dec. 1998
Time machines constructed from anti-de Sitter space; Li L X, Phys Rev D 59 (1999) 084016
Wormholes in string theory, Vollick D N., Class Quant Grav 16(5):1599-1604, 1999
Time machines and the breakdown of unitarity; Antonsen F and Bormann K, Int J Theor Phys 37(9): 2383-2393, 1998
An exterior for the Godel spacetime; Bonnor W B, Santos N O, MacCallum M A H, Class. Quant. Grav. 15 (1998) 357-366
All the worlds a time machine, Chown M, New Scientist 157(2124): 38-41, 1998 Mar. 7.
   [short exposition of M. Hadleys idea that an elementary particle is a local ST warp that it permits closed timelike curves. Hence general relativity could reproduce (explain) the effects of QM]
Quantum time machine; Gonzalez-Diaz P F Phys Rev D 58 (12): 4011, 1998
A design for a quantum time machine, Gray A quant-ph/9804008
   {misleading title. On QM measurement problem; quantum “seeing into future.”}
Time machines with non-compactly generated cauchy horizons and “handy singularities”; Krasnikov S V, gr-qc/9711040 (To appear in the proceedings of the 8th Marcel Grossman Conference)
A singularity-free WEC-respecting time machine, Krasnikov S V, Class Quant Grav 15 (1998) 997-1003
Self-consistent vacuum for Misner space and the chronology protection conjecture, Li L X and Gott J R, Phys Rev Lett 80, 2980, 1998
   {Misner space stable to quantum flutuations; against CPC}
Decoherence caused by topology in a time-machine spacetime; Mensky M B and Novikov I D, Int. J. Mod. Phys. D5 (1996) 1-27
Godel metric as a squashed anti-de Sitter geometry, Rooman M, Spindel Ph, Class Quant Grav 15 (1998) 3241-3249
Testing causality violation on spacetimes with closed timelike curves; Rosenberg S, Phys Rev D 57(6):3365-3377, 1998
   {politzer TM used to investigate the scattering experiment; interesting results on agreement with the no CTC case if there is enough TM's}
A new non-Hausdorff spacetime model for resolution of the time travel paradoxes; Sharlow M F Annals of Physics 263(2): 179-197, 1998
Particle creation near the chronology horizon; Sushkov S V, Phys Rev D 58, 1998, 044006
Divergences in the effective action of acausal spacetimes, Cassidy M J, Class Quant Grav 14 p 523, 1997 {shows that a self-consistent quantum vacuum for Misner space exist, allowing time travel}
The 1-loop instability of Misner space; Cassidy M J, Class Quant Grav 15 (8),
Superluminal subway—the Krasnikov tube; Everett A E and Roman T A, Phys Rev D 56 (4): 2100-2108, 1997
Time machines and the principle of self-consistency as a consequence of the principle of stationary action (ii)—the Cauchy problem for a self-interacting relativistic particle, Carlini A and Novikov I D, Int J Mod Phys D 5(5): 445-479, 1996 Oct.
Warp drive and causality, Everett A E, Phys Rev D 53 (12) pp 7365-7368, 1996 Ringholes and closed timelike curves, Gonzalez-Diaz P F Phys Rev D 54(10): 6122-6131, 1996
Time machine as four-dimensional wormhole; Guts A K gr-qc/9612064
Gott time machines in the Anti-de Sitter space; Holst S, Gen Rel Grav 28 (1996) 387-403
The quantum stability of the time machine, Krasnikov S V, Phys Rev D54 (1996) 7322-7327
Must time machine be unstable against vacuum fluctuations?, Li L X, Class Quant Grav 13 (1996) 2563-2568
Three-dimensional billiards with time machine, Mensky M B and Novikov I D, Int J Mod Phys D 5(2): 179-192, 1996
Decoherence caused by topology in a time-machine spacetime, Mensky M B and Novikov I D, Int J Mod Phys D 5(1): 1-27, 1996.
Improved time-machine model; Soen Y and Ori A, Phys Rev D 54(8): 4858-4861,
Unitarity restoration in the presence of closed timelike curves; Anderson A, Phys Rev D51 (1995) 5707-5715
Problems in time-machine construction due to wormhole evolution; Antonsen F and Bormann K, Int J Theor Phys 34 1995, p 2061
Time machines: the principle of self-consistency as a consequence of the principle of minimal action; Carlini A, Frolov V P, Mensky M B, Novikov I D, and Soleng H H, Int J Mod Phys D4 (1995) 557-580; Erratum-ibid. D5 (1996) 99
Nonlinearity in quantum theory and closed timelike curves; Cassidy M J, Phys Rev D52 (1995) 5676-5680
Unitarity of Quantum Theory and Closed Time-Like Curves; Fewster C J, Wells C G, Phys Rev D52 (1995) 5773-5782
Time machines without closed causal geodesics; Low R J, Class Quant Grav 12(5): L 37-L 38, 1995 May.
A remark on kinks and time machines; Yurtsever U, Gen Rel Grav 27(6): 691-693, 1995
The warp drive: hyper-fast travel within general relativity; Alcubierre M, Class Quantum Grav 11, L73 (1994)
Energy-momentum restrictions on the creation of Gott time machines; Carroll S M, Farhi E, Guth A H and Olum K D, Phys Rev D 50 pp 6190-6206, 1994
Kinks and time machines; Chamblin A, Gibbons G W and Steif A R, Phys Rev D 50(4) pp R2353-R2355, 1994
The breakdown of quantum mechanics in the presence of time machine, Goldwirth D S, Perry M J and Piran T, Gen Rel Grav 25 pp 7-13 1994
Quantum propagator for a nonrelativistic particle in the vicinity of a time machine; Goldwirth D S, Perry M J, Piran T and Thorne K S, Phys Rev D 49(8): 3951-3957, 1994
Time machine, self-consistency and the foundations of quantum mechanics; Gonella F, Found Phys Lett 7(2): 161-166, 1994
Time walk through the quantum cosmic string; Gonzalez-Diaz P F, gr-qc/9412034
Unitarity and causality in generalized quantum mechanics for nonchronal spacetimes; Hartle J B, Phys Rev D 49 (12) pp 6543-6555, 1994
(2+1)-dimensional spacetimes containing closed timelike curves; Headrick M P, Gott J R; Phys Rev D 50, 1994, 7244-7259
Time travel, Jackiw R.; Ukrainskii Fizicheskii Zhurnal. 39(1): 6-14, 1994.
On the classical stability of a time machine; Krasnikov S V, Class Quant Grav 11 (11): 2755-2759, 1994 Nov.
Isometries between Gott's two-string spacetime and Grant's generalization of Misner space, Laurence D, Phys Rev D 50 pp 4957-4965
Negative Energy Densities in Extended Sources Generating Closed Timelike Curves in General Relativity with and without Torsion; Soleng H H, Phys Rev D49 (1994) 1124-1125
Multiparticle solutions in 2+1 gravity and time machines; Steif A R, Int J Mod Phys D 3(1): 277-280, 1994
VanVleck determinants—traversable wormhole spacetimes; Visser M
Algebraic approach to quantum field theory on non-globally-hyperbolic spacetimes; Yurtsever U, Class Quant Grav 11 (1994) 999
Cosmic strings and chronology protection; Grant J DE, Phys Rev D 47, 2388 (1993)
Complex geometry, quantum tunneling, and time machines; Li L X, Xu J M and Liu L, Phys Rev D 48(10): 4735-4737, 1993
Quantum field theory in spaces with closed time-like curves; Boulware D G, Phys Rev D46 (1992) 4421-4441
Global structure of Gott's two-string spacetime; Cutler C, Phys Rev D 45 p. 487-494, 1992 {Cauchy horizons for Gott's machine (two-string space-time)}
“Cosmic flashing” in four dimensions; Ford L H and Roman T A, Phys Rev D 46, 1328-1339 (1992)
Unitarity of interacting fields in curved spacetime; Friedman J L Papastamatiou, Phys Rev D 46 4442, 1992
Feilure of unitarity for interacting fields on spacetimes with closed timelike curves; Friedman J L Papastamatiou, and Simon J Z, Phys Rev D 46 4456-4469, 1992
Particle creation for time travel through a wormhole; Kim S W, Phys Rev D 46 2428-2434, 1992
Time machine and self-consistent evolution in problems with self-interaction; Novikov I D, Phys Rev D 45 p. 1989, 1992
Structure of the singularity inside a realistic rotating black hole, Phys Rev Lett} 68, 2117-2120; Ori A (1992)
Simple quantum systems in spacetimes with closed timelike curves; Politzer H D, Phys Rev D 46 4470-4476, 1992
Quantum mechanics near closed timelike lines; Deutsch D, Phys Rev D 44 (10) p 3197-3217 1991
Billiard balls in wormhole spacetime with closed timelike curves: Classical theory; Echeverria F, Klinkhammer G and Thorne K S, Phys Rev D 44 (4) p. 1077-1099, 1991
Closed timelike curves produced by pairs of moving cosmic strings: Exact solutions; Gott J R, Phys Rev Left 66, 1126, (1991)
Inner structure of a charged black hole: An exact mass-inflation solution; Ori A, Rev Left 67: 789, 1991
On the outcome of Kerr-like collapse; Charlton N and Clarke C J S, Classical and Quantum Gravity 7 No. 5 (May 1990)
Cauchy problem in spacetimes with closed timelike curves; Friedman J, Morris M S, Novikov I D, Echeverria F, Klinkhammer G, Thorne K S and Yurtsever U, Phys Rev D 42 (6) 1915-1930, 1990 {QM fixes the TM classical billiard paradox (Polchinski's prdx. “CTC's may be not as nasty as people have assumed”. The principle of self-consistency in time travel reviewed.}
Traversable wormholes from surgically modified Schwarzschild spacetimes, Visser M, Nucl Phys B 328 pp 203-212
Traversable wormholes: some simple examples; Visser M; Phys Rev D 39: 3182-3184 1989
Minimal acceleration requirements for time travel in Godel spacetime; Malament D, Journal of Mathematical Physics 26, 1985, p 774-777
Timelike nongeodesic trajectories which violate causality: A rigorous derivation; de Felice F, Nuovo Cimento 65 B pp 224-232, 1981
Rotating cylinders and the possibility of global causality violation; Tipler F J, Phys Rev D 9 pp 2203-2206, 1974
Global structure of the Kerr family of gravitational fields, Carter B, Phys Rev 174, p 1559, 1968
Complete analytic extension of the symmetry axis of Kerr's solution of Einstein's equations, Carter B, Phys Rev 141, p 1242, 1966
Acta Physica Polonica, Staruszkiewicz A 24 1963, p 734
An example of a new type of cosmological solutions of Einstein's field equations of gravitation, Goedel K, Rev Mod Phys 21 p. 447, 1949
Gravitational field of a distribution of particles rotating about an axis of symmetry; Van Stockum W J, Proc R Soc Edin 57 pp 135-154, 1937

Appendix A: The Synthetic creation of micro singularities. Throughout this patent application the creation of micro singularities has been maintained. While at first glance this may seem to be a deficiency in the patent application it is in fact an engineering problem that is in the process of being solved. In the International Journal of Theoretical Physics 41 (11): 2073-2090, November 2002 L. J. Garay published “Black Holes in Bose-Einstein Condensates”. In this article Garay showed that there exist both dynamically stable and unstable dilute-gas Bose-Einstein condensates that, in the hydrodynamic limit, exhibit a behavior completely analogous to that of gravitational black holes. This discovery coupled with creation of color glass condensate (CGC) an extreme form of nuclear matter in which a nucleus travels at near-light (relativistic) speed which flattens like a pancake in its direction of motion and spawns a large number of gluons hold the key to high energy singularity formation.

I claim:

1. A method for the generation of a pseudo 2+1 dimensional anti-de Sitter space comprising the steps of:
creating two Kerr type positively charged rotating dilation singularities, including the steps of
maintaining one of the singularities as a axis of rotation reference singularity,
maintaining the other of the singularities as a target singularity, and
subjecting the target singularity to a differential electron flow so as to simultaneously pass the differential electron flow above a photosphere of said target singularity in a direction of rotation thereof and contrary to the direction of rotation thereof, in order to release a directed flow of gravitons in a sinusoidal oscillation simulating a rotational effect of the target singularity around the axis of rotation provided by the reference singularity.

2. A method of generating a force around a body, comprising the steps of:
employing sinusoidal oscillations of electrical bombardment on the surface of one Kerr type reference singularity in close proximity to a second Kerr type target singularity to take advantage of the Lense-Thirring effect, wherein the electrical currents employed in the bombardment are passed simultaneously across the photosphere of said reference singularity in its direction of rotation and contrary to its direction of rotation to release a directed flow of gravitons in a sinusoidal oscillation simulating a rotational effect of the target singularity around the axis of rotation provided by the reference singularity;
creating timelike curves in a compact time-oriented manifold of G\ddot{}odel-type geodesically complete spacetime envelope under the Van Den Broeck modification of the Alcubierre geometry, resulting in the creation of timelike curves in a compact time-oriented manifold permitting topology change from one spacelike boundary to the other in accordance with Geroch's theorem.
